(19) United States
(12) Patent Application Publication
(10) Pub. No.: US 2024/0168774 A1
(43) Pub. Date: May 23, 2024

(54) CONTENT PRESENTATION PLATFORM

(71) Applicant: ON24, INC, San Francisco, CA (US)

(72) Inventors: Sharat Sharan, San Francisco, CA (US); Jayesh Sahasi, San Francisco, CA (US); Kamalaksha Ghosh, San Francisco, CA (US); Mahesh Kheny, San Francisco, CA (US); Jaimini Joshi, San Francisco, CA (US)

(21) Appl. No.: 18/283,075

(22) PCT Filed: Apr. 26, 2022
(86) PCT No.: PCT/US2022/026400

§ 371 Date: Sep. 20, 2023

Related U.S. Application Data
(60) Provisional application No. 63/179,760, filed on Apr. 26, 2021.

(51) Int. Cl. G06F 9/451; G06F 9/54; G06F 16/435; G06N 20/00; H04L 67/50

(52) U.S. Cl. CPC G06F 9/451; G06F 9/547; G06F 16/435; G06N 20/00; H04L 67/535

(57) ABSTRACT

Computer-implemented methods, computing systems, apparatuses, and computer-program products for content presentation and distribution are described herein. A distribution platform may comprise a system of computing devices, server devices, software, etc., that is configured to present media assets at user devices. The media assets may be presented at the user devices via a client application associated with the distribution platform. User activity data associated with each instance of the client application at each of the user devices may be monitored. The user activity data may be indicative of one or more user interactions with the media assets at each of the user devices. The user activity data may be used by the distribution system to provide a number of services.

### CROSS-REFERENCE TO RELATED APPLICATION

This application claims the benefit of and priority to U.S. Provisional Patent Application No. 63/179,760, filed Apr. 26, 2021, the contents of which application are hereby incorporated by reference herein in their entireties.

### SUMMARY

It is to be understood that both the following general description and the following detailed description are exemplary and explanatory only and are not restrictive.

Methods, systems, and apparatuses for content presentation and distribution are described herein. A distribution platform may comprise a system of computing devices, servers, software, etc., that is configured to present media assets at user devices. The media assets may be presented at the user devices via a client application associated with the distribution platform. The client application may include multiple interface elements as well as a media player element. The interface elements may allow users of the user device to interact with the media assets via the client application, and the media player element may output (e.g., present, stream, etc.) the media assets.

User activity data associated with each instance of the client application at each of the user devices may be monitored. For example, the distribution platform may monitor (e.g., track, tabulate, etc.) the user activity data during a defined period of time. The user activity data may be indicative of one or more user interactions with the media assets and/or the interface elements at each of the user devices. The user activity data may be used by the distribution system to provide a number of services as further described herein.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods, systems, and apparatuses described herein:

FIG. 1 illustrates an example of an operational environment that includes a content presentation platform for presentation of digital content, in accordance with one or more embodiments of this disclosure;

FIG. 2 illustrates an example of an analytics subsystem included in a content presentation platform for presentation of digital content, in accordance with one or more embodiments of this disclosure;

FIG. 3A illustrates an example of a storage subsystem included in a content presentation platform for presentation of digital content, in accordance with one or more embodiments of this disclosure;

FIG. 3B illustrates an example of a visual representation of a user interest cloud (UIC), in accordance with one or more embodiments of this disclosure;

FIG. 4 illustrates an example of a user interface (UI) that presents various types of engagement data for a user device, in accordance with one or more embodiments of this disclosure;

FIG. 5 schematically depicts engagement scores for example functionality features available per digital experience (or media asset), for a particular end-user, in accordance with one or more embodiments of this disclosure;

FIG. 6 illustrates an example of an operational environment that includes integration with third-party subsystems, in accordance with one or more embodiments of this disclosure;

FIG. 7A illustrates another example of an operational environment for integration with a third-party subsystem, in accordance with one or more embodiments of this disclosure;

FIG. 7B illustrates example components of an integration subsystem, in accordance with one or more embodiments of this disclosure;

FIG. 8A illustrates an example of a UI representing a landing page for configuration of aspects of a digital experience, in accordance with one or more embodiments of this disclosure;

FIG. 8B illustrates an example of a UI, in accordance with one or more embodiments of this disclosure;

FIG. 8C illustrates an example of a UI, in accordance with one or more embodiments of this disclosure;

FIG. 8D illustrates an example of a UI, in accordance with one or more embodiments of this disclosure;

FIG. 8E illustrates an example of a UI, in accordance with one or more embodiments of this disclosure;

FIG. 9 illustrates an example of a subsystem for configuration of aspects of a digital experience, in accordance with one or more embodiments of this disclosure;

FIG. 10 illustrates a schematic example of a layout template for presentation of a media asset and directed content, in accordance with one or more embodiments of this disclosure;

FIG. 11 illustrates another schematic example of a layout template for presentation of a media asset and directed content, in accordance with one or more embodiments of this disclosure;

FIG. 12 illustrates an example of a personalization subsystem in a content presentation platform for presentation of digital content, in accordance with one or more embodiments of this disclosure;

FIG. 13A illustrates example components of a content management subsystem, in accordance with one or more embodiments of this disclosure;

FIG. 13B illustrates an example of a digital experience, in accordance with one or more embodiments of this disclosure;

FIG. 13C illustrates another example of a digital experience, in accordance with one or more embodiments of this disclosure;

FIG. 14A illustrates a virtual environment module, in accordance with one or more embodiments of this disclosure;

FIG. 14B illustrates an example of an interactive virtual environment, in accordance with one or more embodiments of this disclosure;

FIG. 15 illustrates an example of a computing system that can implement various functionalities of a content presentation platform in accordance with this disclosure.

FIG. 16 illustrates an example of a method, in accordance with one or more embodiments of this disclosure;

FIG. 17 illustrates an example of another method, in accordance with one or more embodiments of this disclosure;

FIG. 18 illustrates an example of another method, in accordance with one or more embodiments of this disclosure;

FIG. 19 illustrates an example of another method, in accordance with one or more embodiments of this disclosure;

FIG. 20 illustrates an example of another method, in accordance with the one or more embodiments of this disclosure; and

FIG. 21 illustrates an example of another method, in accordance with the one or more embodiments of this disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The disclosure recognizes and addresses, among other challenges, the issue of distribution of digital content to user devices. Computer-implemented methods, systems, apparatuses, and computer-program products for content presentation and distribution are described herein. A content distribution platform may comprise a system of computing devices, servers, software, etc., that is configured to present media assets at user devices. The media assets may be presented at the user devices via a client application associated with the distribution platform. The client application may include multiple interface elements as well as a media player element. The interface elements may allow users of the user device to interact with the media assets via the client application, and the media player element may output (e.g., present, stream, etc.) the media assets. User activity data associated with each instance of the client application at each of the user devices may be monitored. For example, the content distribution platform may monitor (e.g., track, tabulate, etc.) the user activity data during a defined period of time. The user activity data may be indicative of one or more user interactions with the media assets and/or the interface elements at each of the user devices. The user activity data may be used by the distribution system to provide a number of services as further described herein.

Embodiments described herein, individually or in combination, can improve existing technologies for delivery of digital content. Among other improvements, the embodiments described herein, individually or in combination, can provide superior flexibility in the distribution of digital content and the management thereof relative to existing technologies. Rich digital content can be distributed to various types of user devices via a media presentation service. Such embodiments, individually or in combination, can utilize computing resources (e.g., processor cycles, storage, and/or bandwidth) more efficiently than existing technologies. By assessing user activity data indicative of interaction with digital content, the embodiments of this disclosure can configure digital content that can be rich in interaction features and can be consumed efficiently. Such configuration can provide various types of personalization that permit using computing resources more efficiently by providing personalized functionalities to interact with digital content.

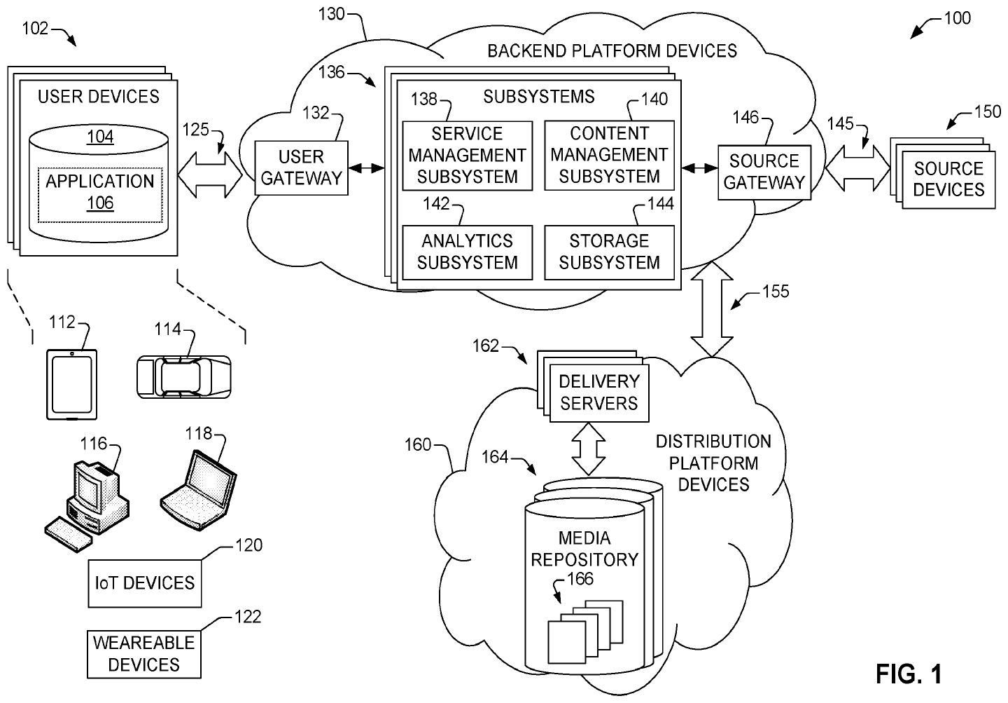

FIG. 1 illustrates an example of an operational environment 100 that includes a content presentation platform for presentation of digital content, in accordance with one or more embodiments of this disclosure. The digital content can be presented as part of a media presentation service. The content presentation platform also can embody, or can include a content distribution platform. The content presentation platform can include backend platform devices 130 and, in some cases, distribution platform devices 160. In other cases, the distribution platform devices 160 can pertain to a third-party provider. The content presentation platform can provide a media presentation service in accordance with aspects described herein. To that end, at least partially, the backend platform devices 130 can form multiple subsystems 136 that provide various functionalities, as is described herein. For example, groups of backend platform devices 130 may form respective ones of the subsystems 136, in some cases. Regardless of its type, the backend platform devices 130 and the distribution platform devices 160 can be functionally coupled by a network architecture 155. The network architecture 155 can include one or a combination of networks (wireless and/or wireline) that permit one-way and/or two-way communication of data and/or signaling. The digital content can include, for example, two-dimensional (2D) content, three-dimensional (3D) content, or four-dimensional (4D) content or another type of immersive content. Besides digital content that is static and, thus, can be consumed in time-shifted fashion, digital content that can be created and consumed contemporaneously also is contemplated.

The digital content can be consumed by a user device of a group of user devices 102. The user device can consume the content as part of a presentation that is individual or as part of a presentation involving multiple parties. Regardless of its type, a presentation can take place within a session to consume content. Such a session can be referred to as a presentation session and can include, for example, a call session, videoconference, a downstream lecture (a seminar, a class, a tutorial, or the like, for example). The digital content can be consumed as part of the media presentation service.

The group of user devices 102 can include various types of user devices, each having a particular amount of computing resources (e.g., processing resources, memory resources, networking resources, and I/O elements) to consume digital content via a presentation. In some cases, the group of user devices 102 can be homogeneous, including devices of a particular type, such as high-end to medium-end mobile devices, IoT devices 120, or wearable devices 122. A mobile device can be embodied in, for example, a handheld portable device 112 (e.g., a smartphone, a tablet, or a gaming console); a non-handheld portable device 118 (e.g., a laptop); a tethered device 116 (such as a personal computer); or an automobile 114 having an in-car infotainment system (IVS) having wireless connectivity. A wearable device can be embodied in goggles (such as augmented-reality (AR) goggles) or a helmet mounted display device, for example. An IoT device can include an appliance having wireline connectivity and/or wireless connectivity. In other cases, the group of user devices 102 can be heterogeneous, including devices of a various types, such as a combination of high-end to medium-end mobile devices, wearable devices, and IoT devices.

To consume digital content, a user device of the group of user devices 102 can execute a client application 106 retained in a memory device 104 that can be present in the user device. A processor (not depicted in FIG. 1) integrated into the user device can execute the client application 106. The client application 106 can include a mobile application or a web browser, for example. Execution of the client application 106 can cause initiation of a presentation session. Accordingly, execution of the client application 106 can result in the exchange of data and/or signaling with a user gateway 132 included in the backend platform devices 130. The user device and the user gateways 132 can be functionally coupled by a network architecture 125 that can include one or a combination of networks (wireless or wireline) that permit one-way and/or two-way communication of data and/or signaling. Specifically, the user device can receive data defining the digital content. Such data can be embodied in one or multiple streams defining respective elements of the digital content. For instance, a first stream can define imaging data corresponding to video content, and a second stream can defined audio data corresponding to an audio channel of the digital content. In some cases, a third stream defining haptic data also can be received. The haptic data can dictate elements of 4D content or another type of immersive content.

The user gateway 132 can provide data defining the digital content by identifying a particular delivery server of multiple delivery servers 162 included in the distribution platform devices 160, and then supplying a request for content to that particular delivery server. That particular delivery server can be embodied in an edge server in cases in which the distributed platform devices 160 include a content delivery network (CDN). In some configurations, the particular delivery server can have a local instance of digital content to be provided to a user device. The local instance of digital content can be obtained from one or several media repositories 164 (generically referred to as media repository 164), where each one of the media repositories 164 contain media assets 166. At least some of such assets can be static and can be consumed in time-shifted fashion. At least some of the media assets 166 can be specific to a media repository or can be replicated across two or more media repositories. The media assets 166 can include, for example, a video segment, a webcast, an RSS feed, or another type of digital content that can be streamed, from the distribution platform devices 160, by the user gateway 132 and/or other devices of the backend platform devices 130. The media assets 166 are not limited to digital content that can be streamed. In some cases, at least some of the media assets 166 can include static digital content, such as an image or a document.

The particular delivery server can provide digital content to the user gateway 132 in response to the request for content. The user gateway 132 can then send the digital content to a user device. The user gateway 132 can send the digital content according to one of several communication protocols (e.g., IPv4 or IPv6, for example).

In some embodiments, the digital content that is available to a user device or set of multiple user devices (e.g., a virtual classroom or a recital) can be configured by content management subsystem 140. To that end, the content management subsystem 140 can identify corpora of digital content applicable to the user device(s). Execution of the client application 106 can result in access to a specific corpus of digital content based on attributes of the user device or a combination of the set of multiple user devices.

The subsystems 136 also include an analytics subsystem 142 that can generate intelligence and/or knowledge about content consumption behavior of an end-user consuming digital content, via the media presentation service, using a user device (e.g., one of the user devices 102). The analytics subsystem 142 can retain the intelligence and/or knowledge in a storage subsystem 144. Both the intelligence and knowledge can be generated using historical data identifying one or different types of activities of the end-user. The activities can be related to consumption of digital content. In some configurations, the client application 106 can send activity data during consumption of digital content. The activity data can identify an interaction or a combination of interactions of the user device with the digital content. An example of an interaction is trick play (e.g., fast-forward or rewind) of the digital content. Another example of an interaction is reiterated playback of the digital content. Another example of an interaction is aborted playback, e.g., playback that is terminated before the endpoint of the digital content. Yet another example of the interaction is submission (or “share”) of the digital content to a user account in a social media platform. Thus, the activity data can characterize engagement with the digital content.

The analytics subsystem 142 can then utilize the activity data to assess a degree of interest of the end-user on the digital content, where the end-user consumes content using a user device (e.g., one of the user devices 102). To that end, in some embodiments, the analytics subsystem 142 can train a machine-learning model (such as a classification model) to discern a degree of interest on digital content among multiple interest levels. The machine-learning model can be trained using unsupervised training, for example, and multiple content features determined using digital content and engagement features determined using the activity data. To train the machine-learning model, the analytics subsystem can determine a solution to an optimization problem with respect to a prediction error function. The solution results in model parameters that minimize the prediction error function. The model parameters define a trained machine-learning model. The machine-learning model can rely on one or more content attribute parameters, including, by way of non-limiting examples: content category, descriptions, assigned keywords, assigned keyphrases, presentation content (e.g., graphics or text), and/or audio transcripts to determine the keywords and/or keyphrases that best represent the content. The analytics subsystem 142 can retain retaining such model parameters in data storage. By applying the trained machine-learning model to new activity data in production (or prediction) mode, an interest attribute can be generated. The interest attribute represents one of the multiple interest levels and, thus, quantifies interest on the digital content on part of the user device.

By evaluating interest of an end-user (or, in some cases, a subscriber account corresponding to the end-user) on different types of digital content, the analytics subsystem 142 can generate a user profile for the end-user (or, in some cases, a subscriber account). Such an evaluation can be implemented for multiple end-users (or, in cases the end-user subscribes to the media presentation service, a subscriber account corresponding to the end-users). Therefore multiple user profiles can be generated. A user profile can constitute a user interest cloud (UIC). The UIC can thus identify types of digital content likely to be consumed by an end-user consuming, via a user device, digital content from the content presentation platform. In some cases, a UIC can be categorized according to interest type. For example, a UIC that identifies one or more interest levels in respective media assets within a business context, the UIC can referred to as a business interest cloud (BIC). As another example, a UIC that identifies one or more interest levels in respective media assets within a personal context (e.g., hobbies, advocacy causes, or similar) can be referred to as a personal interest cloud (PIC). Because media assets within a particular context may be overlapping with media assets in another particular context, a UIC can include metadata identifying one or more interest types associated with the UIC.

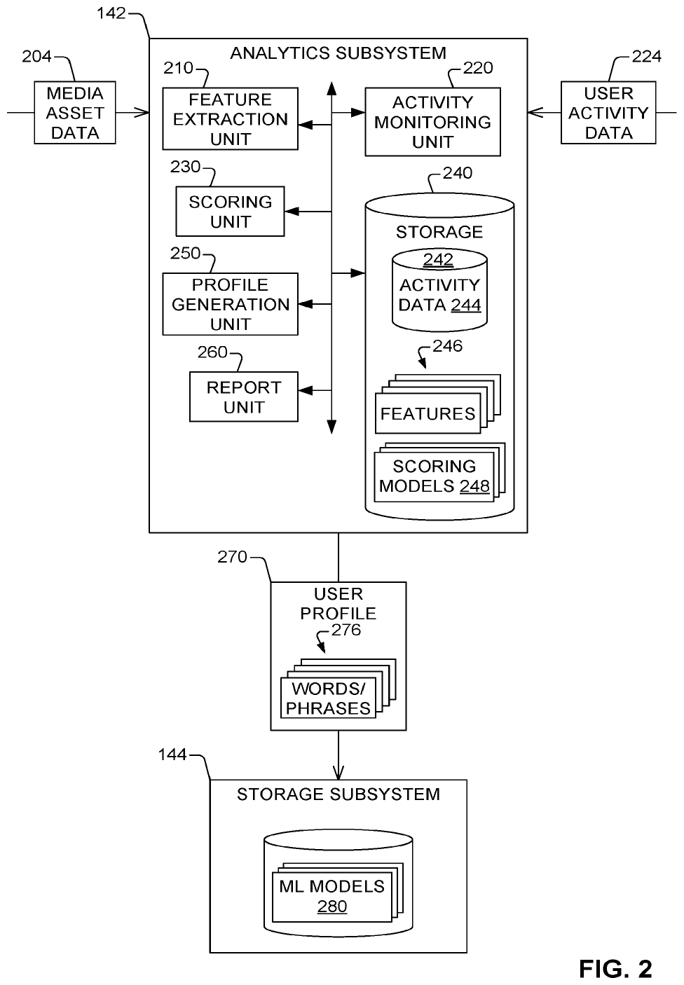

More specifically, as is illustrated in FIG. 2, the analytics subsystem 142 can include multiple units that permit generating a user profile. The analytics subsystem 142 can include a feature extraction unit 210 that can receive media asset data 204 defining a media asset of the media assets 166 (FIG. 1). As mentioned, the media asset can be a webinar, a video, a document, a webpage, a promotional webpage, or similar asset. The feature extraction unit 210 can then determine one or several content features for the media asset. Examples of content features that can be determined for the media asset include, content type (e.g., video, webinar, document (e.g., PDF document), webpage, etc.); content rating; author information (e.g., academic biography of a lecturer); date of creation; content tag; content category; content filter; language of the content; and content description.

Simply as an example, the content description can include an abstract or a summary, such as a promotional summary, a social media summary, and an on-demand summary. The feature extraction unit 210 can determine the content feature(s) for the media asset prior to consumption of the media asset. In this way, the determination of a user profile can be more computationally efficient. The feature extraction unit 210 can retain data indicative of the determined content feature(s) in storage 240, within memory elements 246 (referred to as features 246). The storage 240 can be embodied in one or more memory devices.

In addition, the analytics subsystem 142 can include an activity monitoring unit 220 that can receive user activity data 224 for a user device used by an end-user consuming digital content from the content presentation platform. As mentioned, the client application 106 (FIG. 1) included in the user device can send the user activity data 224. In some cases, the user activity data 224 can be received upon becoming available at the user device. In addition, or in other cases, the user activity data 224 can be received in batches, at defined instants (e.g., periodically, according to schedule, or in response to a defined condition being satisfied). A batch of user activity data 224 can include activity data generated during a defined period of time spanning the time interval between consecutive transmissions of user activity data 224, for example. The user activity data 224 can identify an interaction or a combination of interactions of the user device with the media asset. Again, an interaction can include one of trick play, reiterated playback, aborted play, social media share, or similar. The activity monitoring unit 220 can then generate one or several engagement features using the user activity data 224. In some configurations, an engagement feature can quantify the engagement of the user device with the media asset. For instance, the engagement feature can be a numerical weight ascribed to a particular type of user activity data 224. For example, aborted playback can be ascribed a first numerical weight and social media share can be ascribed a second numerical weight, where the first numerical weight is less than the second numerical weight. Other numerical weights can be ascribed to reiterated playback and trick-play. For such interactions, the number of reiterations and the time spent consuming the media asset due to trick-play can determine the magnitude of respective numerical weights. The feature extraction unit 210 can retain data indicative of the determined engagement feature(s) in the storage 240, within the features 246.

The analytics subsystem 142 also can include a scoring unit 230 that can determine an interest level for the media asset corresponding to the determined content feature(s) and engagement feature(s). To that end, the scoring unit can apply a particular scoring model of scoring models 248 to those features, where the particular scoring model can be a trained classification model that resolves a multi-class classification task. Specifically, in some embodiments, the scoring unit 230 can generate a feature vector including determined content feature(s) and engagement feature(s) for the media asset. The number and arrangement of items in such a feature vector is the same as those of features vectors used during training of the particular scoring model. The scoring unit 230 can then apply the particular scoring model of the scoring models 248 to the feature vector to generate an interest attribute representing a level of interest on the media asset. The classification attribute can be a numerical value (e.g., an integer number) or textual label that indicates the level of interest (e.g., “high,” “moderate,” “low”). Each one of the scoring models 248 can be a machine-learning model. Although the scoring models 248 are illustrated as being retained in the storage 240, the scoring models 248 can be retained in the storage subsystem 144, as part of a library of machine-learning models 280, at various times.

In some instances, a profile generation unit 250 can determine that an interest attribute for a media asset satisfies or exceeds a defined level of interest. In those instances, the profile generation unit 250 can select words or phrases, or both, from content features determined for the media asset. Simply for purposes of illustrations, the profile generation unit 250 can select one or more categories of the media asset and a title of the media asset as is defined within a description of the media asset. A selected word or phrase represents an interest of the end-user on the media asset. The profile generation unit 250 can then generate a user profile 270 that includes multiple entries 276, each one corresponding to a selected word or phrase. The profile generation unit 250 can then retain the user profile 270 in the storage subsystem 144.

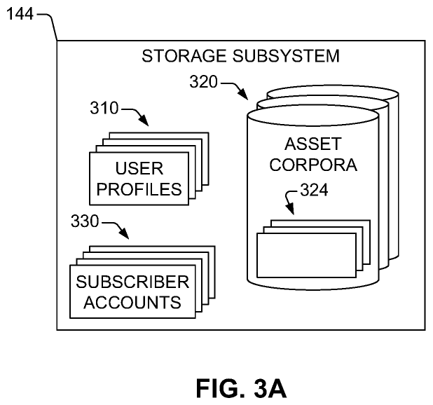

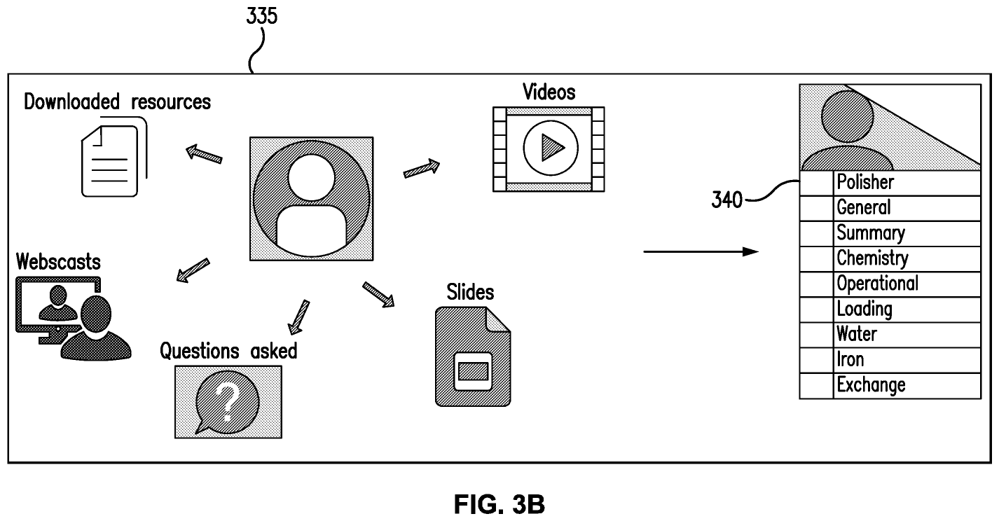

By receiving user activity data 224 from different user devices used by respective end-users consuming digital content from the content presentation platform, the analytics subsystem 142 can generate respective user profiles for those respective end-users (or, in cases the end-user subscribes to the media presentation service, a subscriber account corresponding to the end-users). Thus, as is illustrated in FIG. 3A, the storage subsystem 144 can include user profiles 310. In cases where an end-user consumes media assets from the content distribution platform on a trial or other type of non-binding bases, the storage subsystem can retain the user profiles for a finite period of time, for example. In cases where an end-user has a subscriber account for the media presentation service, a user profile for that user can be retained in the storage subsystem 144, within a subscriber account corresponding to the end-user or in data structure associated with (e.g., linked to) the subscriber account. The subscriber account can be part of subscriber accounts 330 stored in the storage subsystem 144. Such a user profile can be retained within the storage subsystem 144 as long as the subscriber account is retained in the storage subsystem 144.

In addition, or in some embodiments, the content management subsystem 140 (FIG. 1) can then configure digital content that is of interest to the user device. As a result, a particular group of the media assets 166 can be made available to a particular user device or, in cases an end-user subscribes to the media presentation service, a subscriber account corresponding to the end-user. Such a group defines a user-specific corpus of digital content.

In some embodiments, the analytics subsystem 142 can determine digital content that is similar to other digital content that is present in a user-specific corpus of digital content. In some embodiments, to determine that a first media asset and a second media asset are similar, the feature extraction unit 210 (FIG. 2) can determine a similarity metric for the first media asset and the second media asset. The similarity metric can be determined using content features of those media assets. In cases that the similarity metric satisfies or exceeds a threshold value, the first media asset and the second media asset can be deemed to be similar. For example, the similarity metric can be cosine similarity, a Jaccard similarity coefficient, or one of various distances, such as Minkowski distance. The analytics subsystem 142 can generate a recommendation for the similar content and can then send the recommendation or a message indicative of the recommendation to a user device. In some embodiments, the report unit 260 (FIG. 2) can generate such a recommendation. It is noted that, in some embodiments, the content management subsystem 140 can determine similarity between the first media asset and the second media asset. Additionally, the content management subsystem 140 also can generate the foregoing recommendation in cases where the first and second media assets are similar.

In some embodiments, a user profile and a user-specific corpus of digital content for an end-user also can constitute a UIC for the end-user or, in cases the end-user subscribes to the media presentation service, a subscriber account corresponding to the end-user. In addition, or in other embodiments, the content management subsystem 140 can configure one or more functions to interact with digital content. Those function(s) can include, for example, one or a combination of translation functionality (automated or otherwise), social-media distribution, formatting functionality, or the like. The content management subsystem 140 can include at least one of the function(s) in the business interest cloud.

The content management subsystem 140 can retain data defining a UIC within the storage subsystem 144. Accordingly, the storage subsystem 144 can include asset corpora 320 (FIG. 3A) that retains a corpora of media assets 324 for respective user profiles 310. Multiple memory devices can constitute the asset corpora 320. Those memory devices can be distributed geographically, in some embodiments. One or many database management servers (not depicted in FIG. 3A) can manage the asset corpora 320. The database management server(s) can be included in the content management subsystem 140 (FIG. 1).

As is described herein, a corpus of media assets of the corpora of media assets 324 has been determined based on interests of a user corresponding to a subscriber account. Thus, such a corpus of media assets may be referred to as interest cumulus. A first user profile of the user profiles 310 can be logically associated with a first interest cumulus of the corpora of media assets 324, a second user profile of the user profiles 310 can be logically associated with a second interest cumulus of the corpora of media assets 324, and so forth. A logical association can be provided by a unique identifier (ID) for an interest cumulus corresponding to a user profile. The unique ID can be retained in the user profile. The unique ID can be a unique alphanumeric code, such as universally unique identifier (UUID).

FIG. 3B shows an example visual representation 335 of a UIC. As shown in the visual representation 335, the UIC can be based on, for example, the user activity data 224 indicative of the plurality of engagements with one or more of the plurality of media assets. The media assets can include, as an example only, downloaded resources (e.g., media assets and related content); videos; webcasts/webinars; questions asked (e.g., via the client application 106); and slides. As further described herein, a user profile, which can include the BIC, can include multiple entries 276 of words and/or phrases. An example of words and/or phrases that may be included in the multiple entries 276 is shown in the list 340 in the visual representation 335 of the UIC. These words and/or phrases can represent interests of a user corresponding to the user profile, and are derived as is described herein based on the user activity data 224.

Back to referring to FIG. 1, multiple source devices 150 can create digital content for presentation at a user device (e.g., one of the user devices 102). At least a subset of the source devices 150 can constitute a source platform. Such digital content can include, for example, static assets that can be retained in a media repository, as part of the media assets 166. The source device can provide the created digital content to a source gateway 146. The source device can be coupled to the source gateway by a network architecture 145. The network architecture 145 can include one or a combination of networks (wireless and/or wireline) that permit one-way and/or two-way communication of data and/or signaling. The source gateway 140 can send the digital content to the content management subsystem 140 for provisioning of the digital content in one or several of the media repositories 164.

In addition, or in some cases, a source device can configure the manner of creating digital content contemporaneously by means of the client application 106 and other components available to a user device. That is, the source device can build the client application 106 to have specific functionality for generation of digital content. The source device can then supply an executable version of the client application 106 to a user device. Digital content created contemporaneously can be retained in the storage subsystem 144, for example.

The subsystems 136 also can include a service management subsystem 138 than can provide several administrative functionalities. For instance, the service management subsystem 138 can provide onboarding for new service providers. The service management subsystem 138 also can provide billing functionality for extant service providers. Further, the service management subsystem can host an executable version of the client application 106 for provision to a user device. In other words, the service management subsystem 136 can permit downloading the executable version of the client application 106.

With further reference to FIG. 2, the analytics subsystem 142 can retain user activity data 224 over time in a data repository 242, as part of activity data 244. The time during which the user activity data 224 can be retained can vary, ranging from a few days to several weeks. The activity data 244 can include contemporaneous and historical user activity data 224, for example.

The analytics subsystem 142 can include a report unit 260 that can generate various views of the activity data 244 and can operate on at least a subset of the activity data 244. The report unit 260 also can cause a user device to present a data view and/or one or several results from respective operations on the activity data 244. To that end, the user device can include the application 106 and the report unit 260 can receive from the application 106 a request message to provide the data view or the result(s), or both. Further, in response to the request message, the report unit 260 generate the data view and the result(s) and can then cause the application 106 to direct the user device to present a user interface conveying the data view or the result(s). The UI can be presented in a display device integrated into, or functionally coupled to, the user device. The user device can be one of the user devices 102 (FIG. 1).

The request message can be formatted according to one of several communication protocols (e.g., HTTP) and can control the number and type of data views and results to be presented in the user device. The request message can thus include payload data identifying a data view and/or a result being requested. In some cases, the request message can be general, where the payload data identify data view(s) and result(s) defined by the analytics subsystem. For instance, the payload data can be a string, such as “report all” or “dashboard,” or another alphanumeric code that conveys that a preset reporting option is being requested. In other cases, the request message can be customized, where the payload data can include one or more first codes identifying respective data views and/or one or more second codes identifying a particular operation on available activity data 244.

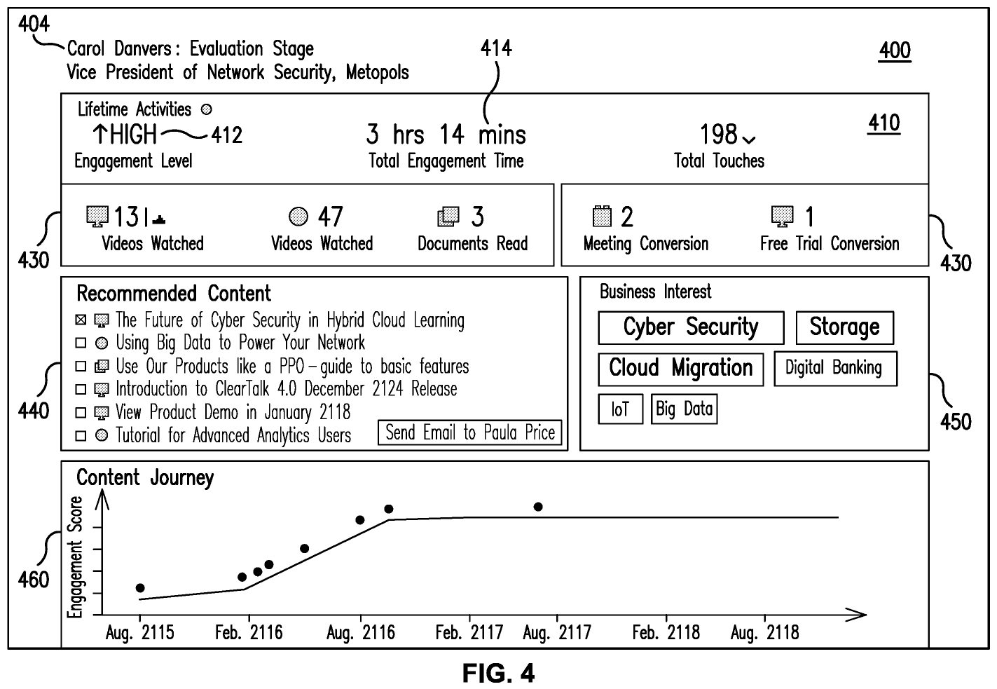

FIG. 4 illustrates an example of a UI 400 that presents various types of engagement data that can be obtained from the activity data 244 for a particular end-user, in accordance with one or more embodiments of this disclosure. The end-user can be, in some cases, a subscriber of the media presentation service. The UI 400 can be referred to as engagement dashboard. The data conveyed in the UI 400 can be obtained in response to a request message including the “dashboard” code or a similar payload data. As is illustrated in FIG. 4, the UI 400 includes indicia 404 identifying an end-user and various panes, each pane presenting a particular data view or an aggregated result. Specifically, the UI 400 includes a first pane 410 that presents engagement level 412 and engagement time 414. In some cases, as is shown in FIG. 4, the engagement time 414 can be a total time since the end-user begun consuming digital content via the media presentation service. In other cases, the engagement time 414 can represent time of consumption of digital content over a particular period of time (e.g., past 7 days, past 14 days, or past 30 days). The UI 400 also includes a second pane 420 that presents engagement activity and a third pane 430 that presents buying activity.

UI 400 includes a fourth pane 440 that presents a menu of content recommendations and a fifth pane 450 that presents at least some of the words/phrases 276 (FIG. 2) pertaining to the user profile corresponding to the end-user. The words and phrases that are presented can be formatted in a way that pictorially ranks the interests of the end-user—e.g., greater font size represents greater interest. Further, the UI 400 also includes a sixth pane 460 that presents an amount of content consumed as a function of time. Such temporal dependence of content consumption can be referred to as “content journey.” By making available the types of engagement data illustrated in the UI 400, a source device can access valuable and actionable insights to optimize a digital experience (or media asset).

The analytics subsystem 142 (FIG. 2) also can contain other scoring models besides the scoring model that can be applied to generate interest level on particular content. By using those other scoring models, the analytics subsystem 142 can generate information identifying features of a digital experience (or media asset) that cause satisfactory engagement (e.g., most engagement, second most engagement, or similar) with an end-user. Accordingly, the analytics subsystem 142 can predict how best to personalize digital experiences (or media assets) for particular customers based on their prior behavior and interactions with media assets supplied by the distribution platform devices 160 (FIG. 1). Accordingly, a source device can access valuable and actionable insights to optimize a digital experience.

More specifically, in some embodiments, the scoring unit 230 (FIG. 2) can apply a defined scoring model to user activity data 224 to evaluate a set of functionality features present in several media assets. Evaluating a functionality feature f includes generating a score S for f Thus, for a set of multiple functionality features {f₀, f₁, f₂ . . . , f_{N-1}}, with N a natural number greater than unity, application of defined scoring model can result in a set of respective scores {S₀, S₁, S₂, . . . , S_{N-1}}. The defined scoring model can be one of the scoring models 248 and can be trained using historical user activity data for many users and media assets.

Simply for purposes of illustration, the functionality features can include (i) real-time translation, (ii) real-time transcription (e.g., captioning) in same language; (iii) real-time transcription in a different language; (iv) access to documents (scientific publications, scientific preprints, or whitepapers, for example) mentioned in a presentation; (v) detection of haptic capable device and provisioning of 4D experience during presentation; (vi) “share” function to custom set of recipients within or outside a social network; (vii) access to recommended content, such as copies of or links to similar presentations and/or links to curated content (e.g., “because you watched “Content A” you might enjoy “Content B”); (viii) messaging with links to cited, recommended, or curated content; (ix) scheduler function that prompts to add invites, adds invites, or sends invites for, live presentations of interest that occur during times that end-user is free; automatically populates a portion of the calendar with those presentations, amount of calendar that can be populated is determined by end-user; or similar functions. Access to a document can include provision of a copy of the document or provision of a link to the document. Similarly, access to content can include provision of a copy of the content or provision of a link to the content.

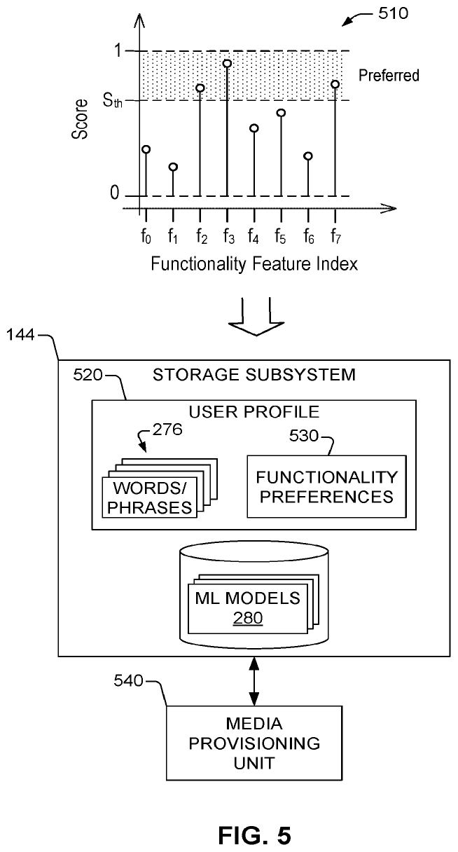

Diagram 510 in FIG. 5 schematically depicts engagement scores for an example case in which N=8 functionality features are available per digital experience (or media asset), for a particular end-user. Each of the features f₀, f₁, f₂, f₃, f₄, f₅, f₆, and f₇ have respective scores. Some of the scores are less than a threshold score Sₜₕ and other scores are greater than Sₜₕ. The threshold score is a configurable parameter that the profile generation unit 250 (FIG. 2) can apply to determine if a functionality feature is preferred by the particular end-user. As is depicted with a dotted area in FIG. 5, a functionality feature f is preferred if the corresponding engagement score S is greater than or equal to Sₜₕ. The score structure for that set of functionality features can differ from end-user to end-user, thus revealing which functionality features are preferred for the end-user. The profile generation unit 250 can determine that respective engagement scores for one or several functionality features are greater than Sₜₕ. In response, the profile generation unit 250 can update a user profile 520 with preference data identifying the functionality feature(s). Thus, the user profile 520 can include words/phrases 276 and functionality preference 530 including that preference data.

In the example depicted in FIG. 5, functionality features f₂, f₃ and f₇ have engagement scores greater than Sₜₕ. Thus, the profile generation unit 250 (FIG. 2) can determine that those features are preferred by the particular end-user. In one example, f₂ can be real-time translation, f₃ can be real-time transcription in a different language from the language of a presentation, and f₇ can be access to documents. The profile generation unit 250 can determine that respective engagement scores for those features are greater than Sₜₕ, and can then update a user profile 520 with preference data identifying features functionality features f₂, f₃ and f₇. As such, the user profile 520 can include words/phrases 276 and functionality preference 530 including that preference data.

The content management subsystem 140 can personalize the digital experiences for an end-user by including the functionality features 530 defined in the user profile 520 pertaining to the end-user. In some embodiments, the content management subsystem 140 can include a media provisioning unit 540 (FIG. 5) that access the functionality preferences 530 and can then generate a UI that is personalized according to the functionality preferences 530. That personalized UI can include the functionality features identified in the functionality preferences 530. In some cases, the media provisioning unit 540 can generate that UI by applying a machine-learning model of the library of machine learning models 280.

In addition, or in other embodiments, the media provisioning unit 540 also can generate a layout of content areas that is personalized to end-user. The personalized layout can include a particular arrangement of one or several UI elements for respective preferred functionalities of the end-user. In some cases, the media provisioning unit 540 can generate the layout of content areas by applying a machine-learning model of the library of machine-learning models 280. Further, or in other embodiments, the media provisioning unit 540 can generate a presentation ticker (such as a carousel containing indicia) identifying live-action presentations near a location of a user device presenting the personalized UI. In addition, or in some cases, the presentation ticker also can include indicia identifying digital experiences (or media assets) that occur during times shown as available in a calendar application of the end-user.

It is noted that the analytics subsystem 142 is not limited to applying scoring models. Indeed, the analytics subsystem 142 can include and utilize other machine-learning (ML) models to provide various types of predictive functionalities. Those other machine-learning models can be retained in the library of machine-learning models 280. Examples of those functionalities include prediction of engagement levels for end-users or prospective subscriber accounts; Q&A autonomous modules to answer routine support questions; and platform audience and presenter load predictions. The analytics subsystem 142 can generate prediction of engagement levels for prospective subscriber accounts by applying a machine-learning model of the library of machine-learning models 280 to registration data indicative of registrations to an event. In addition, or in some cases, the analytics subsystem 142 can generate predictions of load conditions by applying a machine-learning model of the library of machine-learning models 280 to feature vectors including at least one of a first feature defining a number of scheduled events, a second feature defining a number of registrants for each timeslot of a presentation, a first categorical variable for the hour of the day for the presentation, or a second categorical variable for day of the week for the presentation. The service management subsystem 138 (FIG. 1) can use load predictions to identify and configure operational resources and provide oversight. The operational resources include computing resources, such as processing units, storage units, and cloud services, for example.

It is also noted that some of the functionality features provided in a digital experience (or media asset) also can utilize respective ML models. A first ML model can provide automated transcription of audio and/or video into text, thus making a media asset searchable and/or otherwise accessible. A second ML model can provide automated translation of transcripts into multiple languages for global audience reach. In some cases, the first ML model or the second ML model, or both, can be accessed and applied as a service. The first and second ML models can be retained in the library of machine-learning model 280, for example, and the service can be provided by one or more subsystems that may be part of the subsystems 136. The disclosure is not limited in that respect and, in some configurations, the service can be provided by a third-party subsystem.

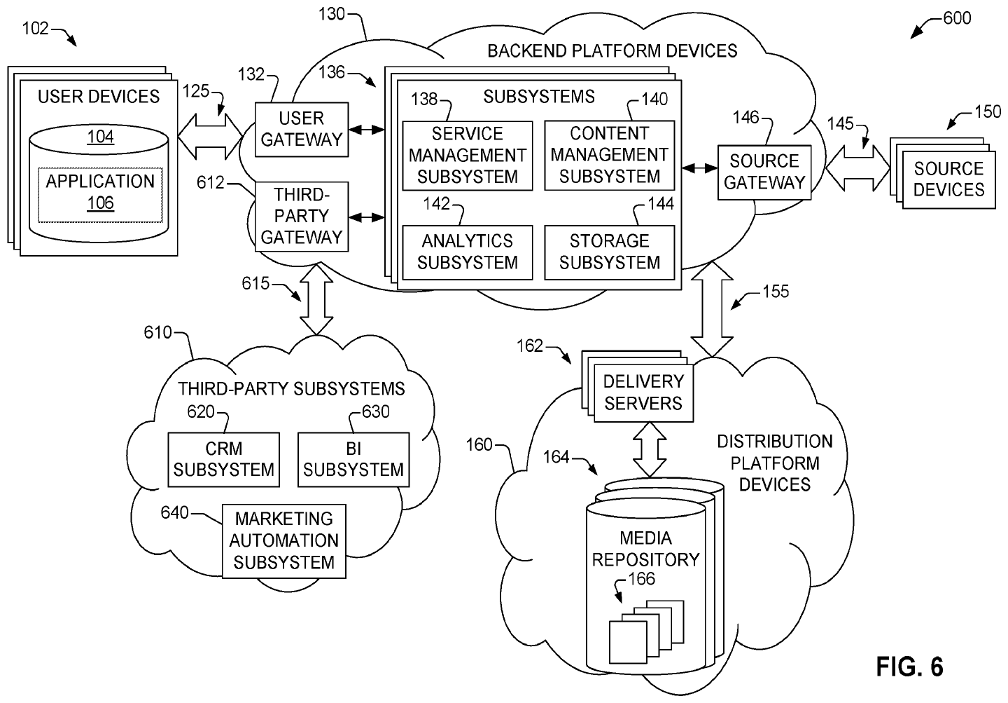

The content presentation platform described in this disclosure can be integrated with a third-party platform. FIG. 6 illustrates an example of an operational environment 600 that includes a content presentation platform integrated with third-party subsystems 610, in accordance with one or more embodiments of this disclosure. Integration of the content presentation platform can be accomplished by functional coupling with the third-party subsystems 610 via a third-party gateway 612 and a network architecture 615. The network architecture 615 can include one or a combination of networks (wireless or wireline) that permit one-way and/or two-way communication of data and/or signaling.

The third-party subsystems 610 can include various type of subsystems that permit first-person insights generated by the analytics subsystem 142 to be extracted and leveraged across business systems of a source platform. As is illustrated in FIG. 6, the third-party subsystems 610 can include a Customer Relationship Management (CRM) subsystem 620, a business intelligence (BI) subsystem 630, and a marketing automation subsystem 640.

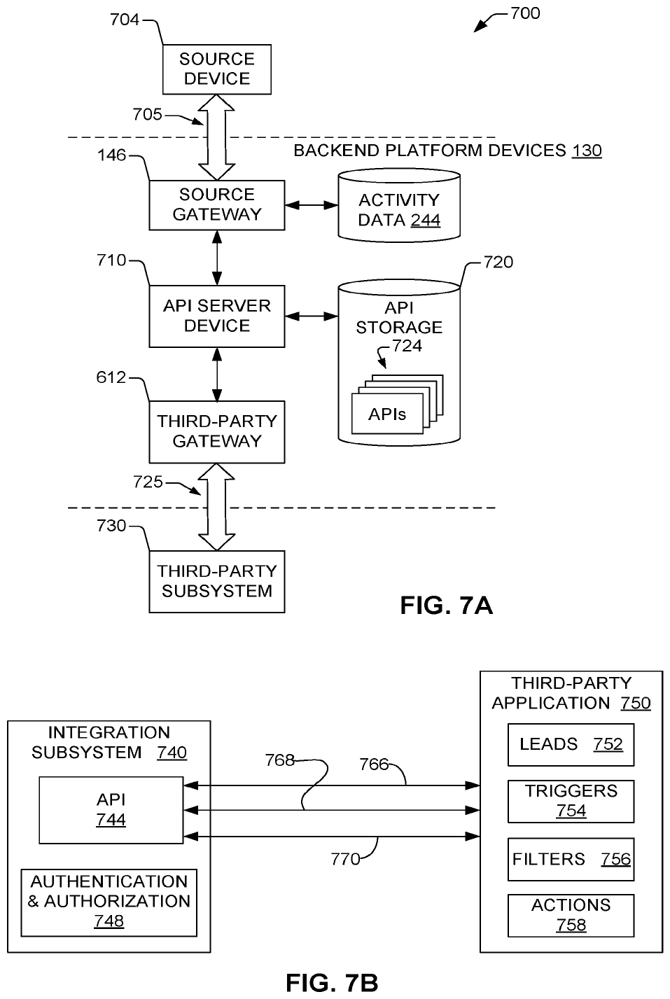

As is illustrated in FIG. 7A, a source device 704 can access an API server device 710 within the backend platform devices 130 (FIG. 1 or FIG. 6) by means of the source gateway 146 and a network architecture 705. The network architecture 705 can be part of the network architecture 145, for example. The API server device 710 can expose multiple application programming interfaces (APIs) 724 retained in API storage 720. An example of an API includes a RESTful API. The disclosure is not limited to that type of API and other types of APIs can be contemplated, such as a GraphQL service, a simple object access protocol (SOAP) service, or a remote procedure call (RPC) API, among others. One or many of the APIs 724 can be exposed to the source device 704 in order to access a third-party subsystem 730 and functionality provided by such a subsystem. The third-party subsystem 730 can be accessed via a network architecture 725. The network architecture 725 can be part of the network architecture 615, for example. The third-party subsystem 730 can be embodied in, or can include, one or more of the CRM subsystem 620, the BI subsystem 630, or the marketing automation subsystem 640 in some cases. The exposed API(s) can permit executing respective groups of function calls, each group including one or multiple function calls. That is, a first exposed API can permit accessing a first group of function calls for defined functionality, and a second exposed API can permit accessing a second group of function calls for defined second functionality. The function calls can operate on data that is contained in the source device 704 and/or a storage system (not depicted in FIG. 7A) functionally coupled to the source device 704. The function calls also can operate on activity data 244 contained in the analytics subsystem 124, for example, with a result of executing a function call being pushed to the source device 704.

Data and/or signaling associated with execution of such function calls can be exchanged between the API server device 710 and the third-party subsystem 730 via the third-party gateway 612. In addition, other data and/or signaling associated with execution of such function calls can be exchanged between the API server device 710 and the source device 704 via the source gateway 146.

In some cases, the API server device 710 also can expose one or many of the APIs 724 to the third-party subsystem 730. In that way, the third-party subsystem 730 (or, in some cases, a third-party device, such as a developer device) can create applications that utilize some of the functionality of the backend platform devices 130.

FIG. 7B illustrates example components of an integration subsystem 740 that can be part of the subsystems 136 (FIG. 1). In some embodiments, the API server device 710 can be part of the integration subsystem 740. The integration subsystem 740 can support an ecosystem of third-party application integrations and APIs that enable the first-person insights generated by the analytics subsystem 142 to be extracted and leveraged across customer business systems. Such first-person insights can be used in various aspects of the operation of a customer business system for richer, more intelligent operation. As an example, first-person insights can be used for more intelligent sales and/or marketing of a product or a service, or both, provided by the customer business system. The integration subsystem 740 can include an API 744 that can be configured to exchange data with one or multiple third-party applications 750. The API 744 (e.g., a RESTful API) can be one of the APIs 724. The third-party subsystem 730 can host at least one of the one or multiple third-party application 750. The one or multiple third party applications 750 can be, for example, a sales application, a marketing automation application, a CRM application, a business intelligence (BI) application, and/or similar application. At least one (or, in some cases, each one) of the third-party applications 750 can be configured to leverage data received from and/or sent to the integration subsystem 740, via the API 744.

In order to exchange data and provide control over certain functionality via the API 744, the integration subsystem 740 may use an authentication and authorization unit 748 to generate an access token. The access token may comprise a token key and a token secret. The access token may be associated with a client identifier. Authentication for API requests may be handled via custom hypertext transfer protocol (HTTP) request headers corresponding to the token key and the token secret. The client identifier may be included in the path of an API request uniform resource locator (URL).

Similar to the APIs 724, the API 744 can include a set of routines, protocols, and/or tools for building software applications. The API 744 may specify how software components should interact. In an embodiment, the API 744 may be configured to send data 766, receive data 768, and/or synchronize data 770. In some cases, the API 744 may be configured to send data 766, receive data 768, and/or synchronize data 770 in substantially real-time, periodically (at defined regular time intervals), responsive to a request, and/or according to other similar mechanisms. The API 744 may be configured to provide the one or more third party applications 750 the ability to access a digital experience (or media asset) functionality, including, for example, event management (e.g., create a webinar, delete a webinar), analytics, account level functions (e.g., event, registrants, attendees), event level functions (e.g., metadata, usage, registrants, attendees), and/or registration (e.g., webinar, or an online portal product as is described herein).

The integration subsystem 740, via the API 744, can be configured to deliver attendance/registration information to at least one of the one or more third party applications 750 to update contact information for Leads 752. The third-party application 750 can use attendance information and/or registration information for lead segmentation, lead scoring, lead qualification, creation of targeted campaigns, or a combination of the foregoing. As an example, a portion of the user activity data 244, such as engagement data (e.g., data indicative of viewing duration, engagement scores, resource downloads, poll/survey responses, or a combination of the foregoing) associated with webinars or other types of media assets can be provided to the third-party application 750 for use in lead scoring and lead qualification to identify leads and ensure effective communication with prospects and current customers.

The integration subsystem 740, via the API 744, can be configured to enable at least one of the one or more third-party applications 750 to use data provided by the integration subsystem 740, via the API 744, to automate workflows. As an example, a portion of the activity data 244, such as engagement data (e.g., data indicative of viewing duration, engagement scores, resource downloads, poll/survey responses, or a combination of the foregoing) associated with webinars or other types of media assets can be provided to at least one of the one or more third-party applications 750 for use in setting one or more triggers 754, filters 756, and/or actions 758. The at least one of the one or more third-party applications 750 can configure a trigger 754. The trigger 754 may be a data point and/or an event, the existence of which may cause an action 758 to occur. In addition, or in some cases, the at least one of the one or more third-party applications 750 can configure a filter 754. The filter 754 can be a threshold or similar constraint applied to the data point and/or the event to determine whether any action 758 should be taken based on occurrence of the trigger 758 or determine which action 758 to take based on occurrence of the trigger 756. Further, or in yet other cases, the at least one of the one or more third-party applications 750 can configure an action 758. The action 758 can be execution of a function, such as updating a database, sending an email, activating a directed content campaign, etc. In this disclosure, a directed content campaign refers to a particular arrangement of delivery and/or presentation of directed content in one or more outlet channels over time. For purposes of illustration, an outlet channel includes a website, a streaming service, or a mobile application. Directed content refers to digital media configured for a particular audience, or a particular outlet channel, or both. The third-party application 750 can receive data (such as engagement data) from the integration subsystem 740, via the API 744, determine if the data relates to a trigger 754, apply any filters 756, and initiate any actions 758. As an example, the third-party application 750 can receive engagement data from the integration subsystem 740 that indicates a user from a specific company watched 30 minutes of a 40 minute video. A trigger 754 can be configured to identify any engagement data associated with the specific company. A filter 756 can be configured to filter out any engagement data associated with viewing times of less than 50% of a video. An action 758 can be configured to send an email to an email address or another type of message to a communication address of the user inviting the user to watch a related video.

In some embodiments, the content management subsystem 140 (FIG. 1) can provide an online portal product that permits providing rich digital experiences for an audience of prospective end-user to find, consume, and engage with interactive digital experiences, including webinar experiences and other media assets, such as videos and whitepapers. The online portal product can be referred to as an “engagement hub,” simply for the sake of nomenclature.

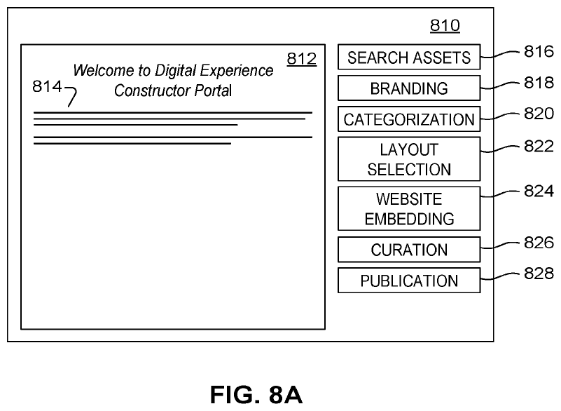

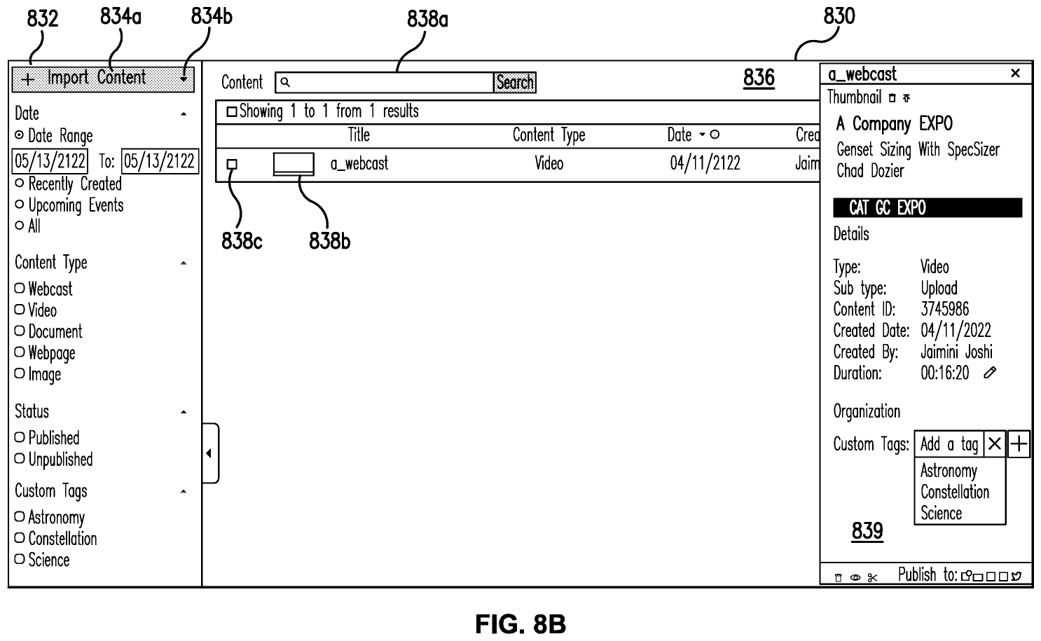

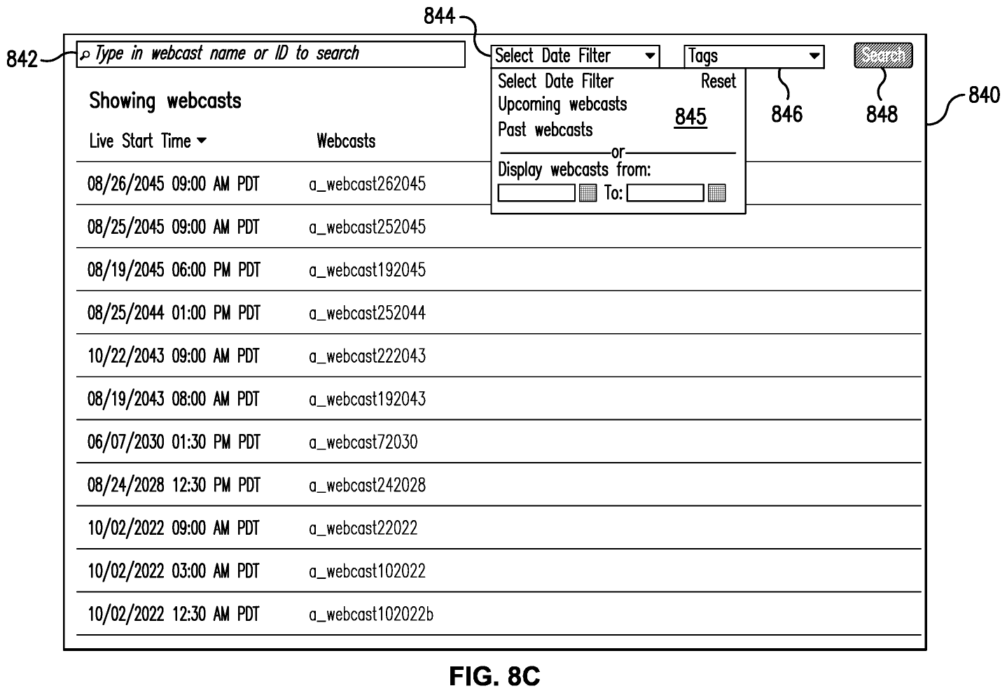

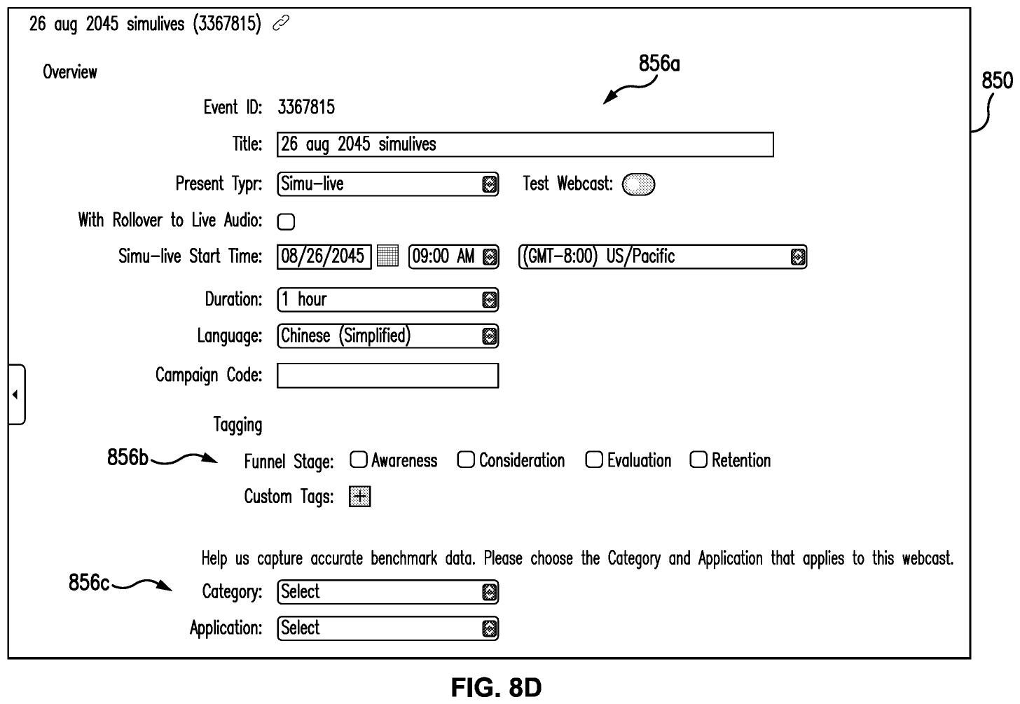

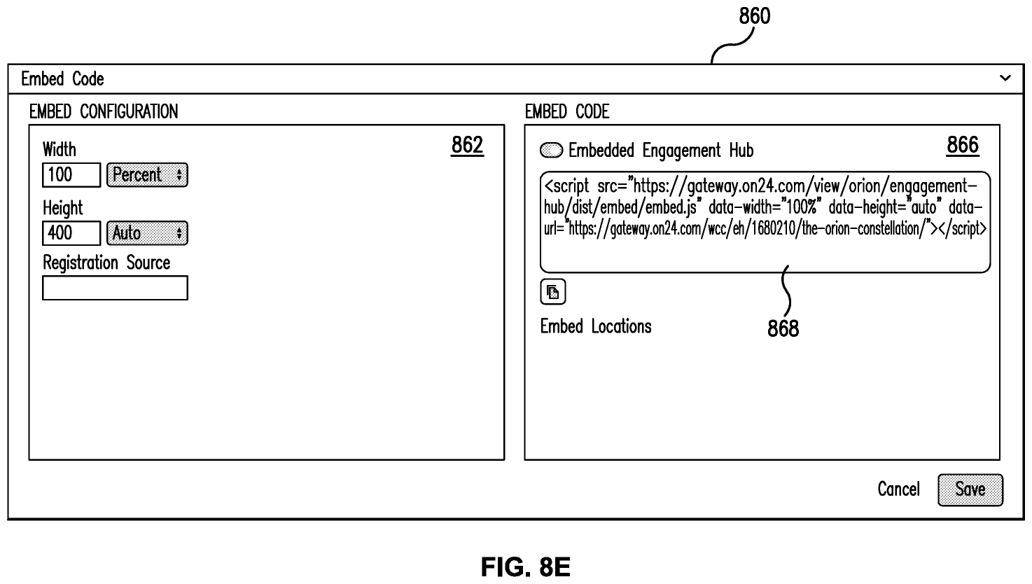

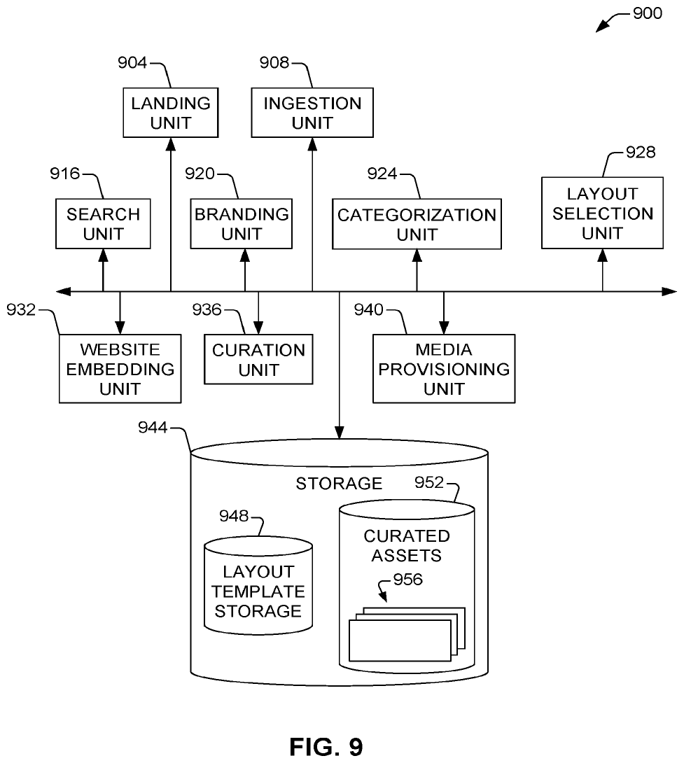

The online portal product provides various functionalities to generate a digital experience (or media asset). As an illustration, FIG. 8A presents an example of a UI 810 representing a landing page of the online portal product, and FIG. 9 illustrates an example of a portal subsystem 900 that provides the functionality of the online portal product. The portal subsystem 900 can be part of the content management subsystem 140 (FIG. 1). As is illustrated in FIG. 8A, the landing page includes a pane 812 that includes a title and a UI element 814 that includes digital content describing the functionality of the online portal product. The title is depicted as “Welcome to Digital Experience Constructor Portal,” simply as an example. A landing unit 904 in the portal subsystem 900 (FIG. 9) can cause the presentation of the UI 900 in response to receiving a request message to access the online portal product from a source device. In some cases, the landing unit 904 can receive such a request message from a source device (e.g., one of the source devices 150 (FIG. 1). In response to receiving the request message, the landing unit 904 can cause the source device to present the UI 810.

The UI 810 (FIG. 8A) also includes several selectable UI elements identifying respective examples of the functionalities that can be provided by the online portal product via the portal subsystem 900. Specifically, in some embodiments, the selectable UI elements include a selectable UI element 816 corresponding to a search function; a selectable UI element 818 corresponding to a branding function; a selectable UI element 820 corresponding to a categorization function; a selectable UI element 822 corresponding to a layout selection function (from defined content layouts), a selectable UI element 824 corresponding to a website embedding function; a selectable UI element 826 corresponding to a curation function; and a selectable UI element 828 corresponding to a provisioning function. The provisioning function also can be referred to as publication function.

Selection of the selectable UI element 816 can cause the source device that presents the UI 810 to present another UI (not depicted in FIG. 8A) to search for a media asset according to one or multiple search criteria. An example of that other UI is UI 830 shown in FIG. 8B. The UI 830 includes a first pane 832 that includes a selectable UI element 834a including a selectable marking 834b. Selection of the selectable marking 834b can cause presentation of several selectable UI elements that permit configuring respective search criteria. The search criteria can be arranged according to fields, such as Date, Content Type, Status, and Custom Tags, for example. Each field can include a subset of the several selectable UI elements. A particular selection of one or more elements of the several selectable UI elements can define a search query including one or more search criteria corresponding to selected element(s). After the search query has been configured, selection of the selectable UI element 834a can send the search query to be resolved as is described herein.

The UI 830 also includes a second pane 836 that can present results responsive to the search query. The second pane 836 also can include a selectable UI element 838a that can permit searching (or filtering) the results according to a query. Input data received via the selectable UI element 838a can define that query. The selectable UI element 838a includes a selectable indicium (shown as “Search”) that, in response to being selected, can send the query to be resolved. In the second pane 836, the results can be presented in tabular form, according to several fields. Some of the fields can be indicative of respective attributes (e.g., Title, Type, Date, or similar fields) of a media asset corresponding to a result. In some cases, a field can include a selectable thumbnail 838b corresponding to a media asset constituting a result responsive to the search query. Selection of the selectable thumbnail 838b can cause presentation of an overlay element 839 that overlays the pane 836. The overlay element 839 can summarize various attributes of the media asset, for example. The second pane 836 also includes a selectable UI element 838c that permits selecting a media asset included in the results. It is noted that while a single result is shown in the pane 836 in FIG. 8B, the disclosure is not limited in that respect.

Another example of a UI to search for media assets is UI 840 shown in FIG. 8C. The UI 840 can include various selectable UI elements that, individually or in combination, permit defining a search query. Those selectable UI elements include a selectable visual element 842 that can receive input data defining an identifier of a media asset or a keyword that may present in the title, a summary, or another type of attribute of the media asset. The selectable UI elements also include a selectable UI element 844 that permits limiting the search to media assets that satisfy a temporal constraint, such as media assets future webcasts, past webcasts, webcasts having a presentation date within a defined time period, or similar. Selection of the selectable UI element 844 can cause presentation of an overlay element 845 having selectable indicia that permits defining the temporal constraint. In addition, the selectable UI elements can include a selectable UI element 846 that permits selecting one or more tags included in metadata pertaining to media assets available for searching. Input data received via the selectable UI element 842, selectable UI element 844, and selectable UI element 846 define the search query.

The UI 840 also includes a selectable UI element 848 that, in response to being selected, causes the search query to be resolved. Results that satisfy the search query can be presented as a list of media assets identified by title and/or a time of scheduled presentation of the media assets, for example.

Media assets can be searched for various configuration purposes. For example, media assets can be searched in order to identify one or several media assets to be augmented with directed content. To search for media assets, in some embodiments, the portal subsystem 900 can include a search unit 916. The search unit 916 can solve a matching problem based on a search query having one or more search criteria to determine one or multiple media assets satisfying the search criteria. The search query can be defined by input data indicative of a selection of one or more selectable UI elements in the pane 832 (FIG. 8B). The search query can be resolved against one or more of the media repositories 164 (FIG. 1). The search unit 916 can then apply a ranking procedure to generate a ranking (or ordered list) of the media asset(s). The search unit 916 can select at least one media asset having a particular placement in the ranking. As mentioned, directed content refers to digital media configured for a particular audience, or a particular outlet channel (such as a website, a streaming service, or a mobile application), or both. Directed content can include, for example, digital media of various types, such as advertisement; surveys or other types of questionnaires; motion pictures, animations, or other types of video segments; podcasts; audio segments of defined durations (e.g., a portion of a speech or tutorial); and similar media.

Selection of the selectable UI element 818 can cause the source device to present another UI (not depicted in FIG. 8A) that permits obtaining digital content to incorporate into a particular media asset. The digital content can identify the particular media asset as pertaining to a source platform that includes the source device. In some cases, the digital content can be embodied in a still image (e.g., a logotype), an audio segment (e.g., a jingle), or an animation. As such, an example of that other UI can be the UI 830 (FIG. 8B) where, for example, a preset combination of fields can be configured in order to generate a search query to obtain that type of digital content. More specifically, responsive to selection of the selectable UI element 818, some of the fields in the pane 832 may not be available for selection or may not be presented.

In some embodiments, the portal subsystem 900 can include a branding unit 920 that can cause or otherwise direct the source device that presents the UI 810 to present another UI in response to selection of the selectable UI element 818. The branding unit 920 can receive, from the source device, input data indicative of such a selection. Again, that other UI can be UI 830 where the pane 832 is presented in accordance with the foregoing preset features. Indeed, the branding unit 920 can generate the preset combination of fields. The branding unit 920 can then resolve the preset search query against one or more of the media repositories 164 or a local repository within the source platform. That other UI can permit the source device to upload the digital content to an ingestion unit 908. To that end, a result responsive to the preset search query and indicative of available digital content can be selected. More specifically, the selectable UI element 838c (FIG. 8B) can permit selecting such a result, as is described herein. Selection of the digital content (e.g., a jingle or logotype, for example) can cause the upload of the digital content to the ingestion unit 908. The ingestion unit 908 can receive the digital content and can retain the digital content in the storage 944. That other UI also can permit browsing digital content available for branding at the storage subsystem 144 (FIG. 1). The source device can request, using that other UI, that the ingestion unit 908 obtain particular digital content from the storage subsystem 144 (FIG. 1) for example.

Selection of the selectable UI element 820 can cause the source device that presents the UI 810 to present another UI (not depicted in FIG. 8A) to categorize multiple media assets according to multiple categories. An example of that other UI is UI 840 shown in FIG. 8D. The UI 850 includes contains several UI elements that permit configuring attributes of a media asset (such as a webcast). The UI 850 in particular permit configuring general attributes of a media asset. The general attributes can define an overview of the media asset, including a category of the media asset. More specifically, the UI 850 can include a first group of selectable UI elements 856a that permit configuring presentation attributes of the media asset (e.g., a webinar having a defined identifier (ID)). The UI 850 also includes a second group of selectable UI elements 856b that permit configuring tags or other metadata for the media asset. That metadata can be interactively customized. Additionally, the UI 850 can include a third group of selectable UI elements 856c that permit configuring a category of the media asset. That third group also can permit configuring an application that can present or can facilitate presentation of the media asset. In some cases, the UI 850 also can include a pane having multiple selectable indicia (e.g., selectable text) that in response to being selected can cause presentation of user interfaces that individually permit configuring one or more other aspects of a media asset. In addition, or in other cases, the UI 850 can include indicia conveying presenter information, including communication address(es) (such as telephone number(s)) and/or access credentials.

In some embodiments, the portal subsystem 900 can include a categorization unit 924 that can cause or otherwise direct presentation of the other UI in response to selection of the selectable UI element 820. The categorization unit 924 can receive, from the source device, input data indicative of such a selection. For example, the input data can be indicative of a particular category selected using a selectable UI element of the third group of selectable UI elements 856c. The categorization unit 924 also can classify a media asset according to one of the several categories.

Selection of the selectable UI element 822 can cause the source device that presents the UI 810 to present another UI (not depicted in FIG. 8A) to select a layout of areas for presentation of digital content. A first area of the layout of areas can be assigned for presentation of a media asset that is being augmented with directed content, for example. At least one second area of the layout of areas can be assigned for presentation of the directed content. In some embodiments, the portal subsystem 900 can include a layout selection unit 928 that can cause presentation of the other UI in response to selection of the selectable UI element 822. The selection unit 928 can receive, from the source device, input data indicative of such a selection. In response to the selection, the selection unit 928 can cause or otherwise direct the source device to present that other UI. In one example, the layout selection unit 928 can cause presentation of a menu of defined layout templates. Each one of the defined layout templates defines a respective layout of areas for presentation of digital content. Data defining such a menu can be retained in a layout template storage 948. In response to receiving input data identifying a selection of a particular defined layout template, the layout selection unit 928 can configure that particular defined layout for presentation of the media asset and directed content.

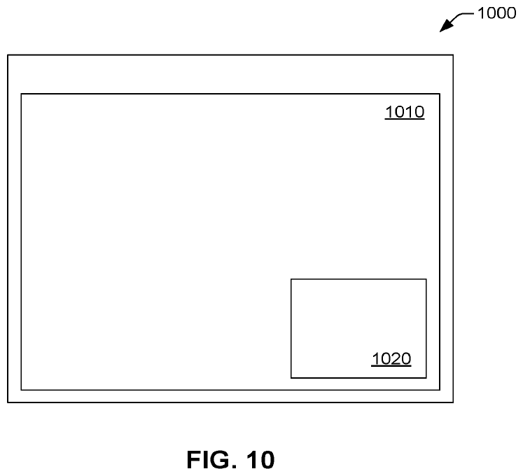

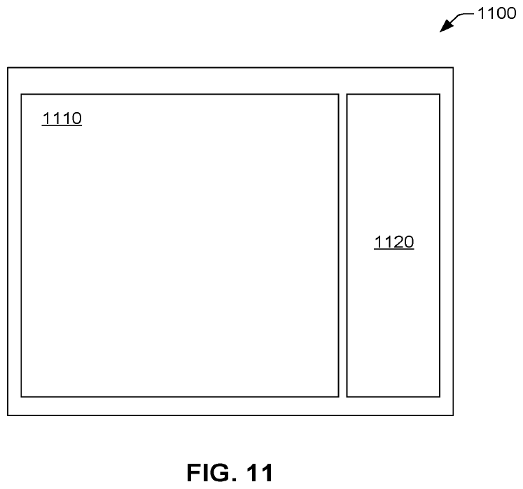

FIG. 10 and FIG. 11 illustrate respective examples of layout templates. In FIG. 10, an example layout template 1000 includes a first area 1010 that can be allocated to the media asset and a second area 1020 that can be allocated to the directed content. As is shown in FIG. 10, the directed content can be overlaid on the media asset. In FIG. 11, an example layout template 1100 includes a first area 1110 that can be allocated to the media asset and a second area 1120 that can be allocated to the directed content. The second area 1120 is adjacent to first area 1110. Thus, rather than presenting the directed content as an overlay, the directed content is presented adjacent to the media asset.

With further reference to FIG. 8A, selection of the selectable UI element 824 can cause the source device that presents the UI 810 to present another UI (not depicted in FIG. 8A) to configure website-embedding of directed content or another type of digital content. An example of that other user interface is UI 850 shown in FIG. 8E. The UI 860 includes a first pane 862 that includes selectable UI elements that permit defining viewport attributes (e.g., viewport height and viewport width). Those various attributes can be defined in various units, such as percentage points relative to available display area, points, inches, or similar units. The UI 860 also includes a second pane 866 that includes a selectable UI element 868 that permit defining embedding code. To that end, in some embodiments, the portal subsystem 900 can include a website embedding unit 932. The website embedding unit 928 can receive, from the source device, input data indicative of such a selection. In response to the selection, the website embedding unit 928 can cause or otherwise direct the source device to present that other UI. For example, the source device can present UI 860, and can receive configuration data defining viewport attributes, such as viewport width and viewport height, and embedding code defining a media asset. The website embedding unit 928 can embed the media asset into a user interface used to consume digital content. To that point, the website embedding unit 928 can use the viewport attributes defined by the configuration data, and various types of embedding techniques. For example, the website embedding unit 932 can embed the media asset using a control element that can include the viewport attributes and the embedding code. The control element can be the inline frame tag (<iframe>) available in hypertext markup language (HTML). As another example, the website embedding unit 932 can embed the media asset using native embedding based on Javascript-SDK. Accordingly, by accessing viewport attributes and embedding code independently of one another, the embedding unit 928 can provide responsive layout design that can support a variety of layouts.

Selection of the selectable UI element 826 can cause the source device that presents the UI 810 to present another UI (not depicted) to curate directed content (or another type of digital content) that can be presented in conjunction with media assets. As such, an example of that other UI can be the UI 830 (FIG. 8B) where, for example, a preset combination of fields can be configured in order to generate a preset search query to obtain directed content assets. More specifically, responsive to selection of the selectable UI element 826, some of the fields in the pane 832 may not be available for selection or may not be presented, and the Content Type field may include a UI element (not depicted in FIG. 8B) that indicates the content type as being directed content.

In some embodiments, the ingestion unit 908 can obtain multiple directed content assets that satisfy the present search query, and can cause or otherwise direct the source device to present such directed content assets. The multiple directed content assets can be presented in various formats. In one example, the multiple directed content assets can be presented as respective thumbnails. In another example, the multiple directed content assets can be presented in a selectable carousel area. The portal subsystem 900 also can include a curation unit 936 that cause presentation of the other UI (e.g., UI 830) in response to selection of the selectable UI element 826. The curation unit 936 can receive, from the source device, input data indicative of such a selection. In response to the selection, the curation unit 936 can cause or otherwise direct the source device to present that other UI.

In addition, in some cases, the curation unit 936 can receive input data indicating approval of one or several directed content assets for presentation with media assets. To that end, one or more results responsive to the preset search query and indicative of available directed content assets can be selected. More specifically, the selectable UI element 838c (FIG. 8B) can permit selecting respective ones of such result(s), as is described herein. Selection of directed content assets can cause the curation unit 936 to approve the selected directed content asset(s). In other cases, the curation unit 936 can evaluate each one the multiple directed content assets obtained by the ingestion component 908. An evaluation that satisfies one or more defined criteria results in the directed content asset being approved for presentation with media assets (e.g., a webinar or another type of presentation).

Regardless of approval mechanism, the curation unit 936 can then configure each one of the approved directed content asset(s) as being available for presentation. To configure a directed content asset in such a manner, the curation unit 936 can add metadata to the directed content asset. The metadata can be indicative of approval for presentation. The approval and configuration represent the curation of the approved directed content asset(s). The curation unit 936 can update a corpus of curated directed content assets 956 within a curated asset storage 952 in response to curation of one or multiple directed content assets.

The portal subsystem 900 also can include a media provisioning unit 940 that can configure presentation of a media asset based on one or a combination of the selected digital content that identifies the source platform, one or several curated directed content assets, and a selected defined layout. To that end, in some cases, the media provisioning unit 940 can generate formatting information identifying the media asset, the selected digital content (e.g., a logotype), the curated directed content asset(s), and the selected defined layout. The media provisioning unit 940 can integrate the formatting information into the media asset as metadata. The metadata can control some aspects of the digital experience that includes the presentation of the media asset.

In addition, or in other cases, the media provisioning unit 940 also can configure a group of rules that control presentation, at a user device, for example, of directed content during the presentation of the media asset. As an example, the media provisioning unit 940 can configure a rule that dictates an instant in which the presentation of the directed content begins and a duration of that presentation. Further, or as another example, the media provisioning unit 940 can configure another rule that dictates a condition for presentation of the directed content and a duration of the presentation of the directed content. Examples of the condition include presence of a defined keyword or keyphrase, or both, in the media asset; presence of defined attributes of an audience consuming the media asset; or similar conditions. An attribute of an audience includes, for example, location of the audience, size of the audience, type of the audience (e.g., students or C-suite executives, for example), or level of engagement of the audience. In some embodiments, an autonomous component (referred to as bot) can listen to a presentation and can perform keyword spotting or more complete speech recognition to detect defined keywords or keyphrases. That autonomous component can be part of the media provisioning unit 940 or can external and functionally coupled to the media provisioning unit 940.

In some embodiments, rather than configuring the rules that control presentation, at a user device, for example, of directed content during the presentation of a media asset, the media provisioning unit 940 can access one or multiple preset rules from the data storage 944. The preset rule(s), individually or in combination, also control presentation, at a user device, for example, of directed content during the presentation of a media asset. The present rule(s) can be interactive configured interactively, via a user interface that presents one or multiple selectable UI elements that, individually or in combination, can permit defining such rule(s). That user interface can be presented at a source device, for example.

As a result, the online portal product provides a straightforward and efficient way for a source device to seamlessly publish, curate, and promote their interactive webinar experiences alongside directed content that a source device can upload and host inside the content presentation platform described herein in connection with FIG. 1 or FIG. 6, or both.

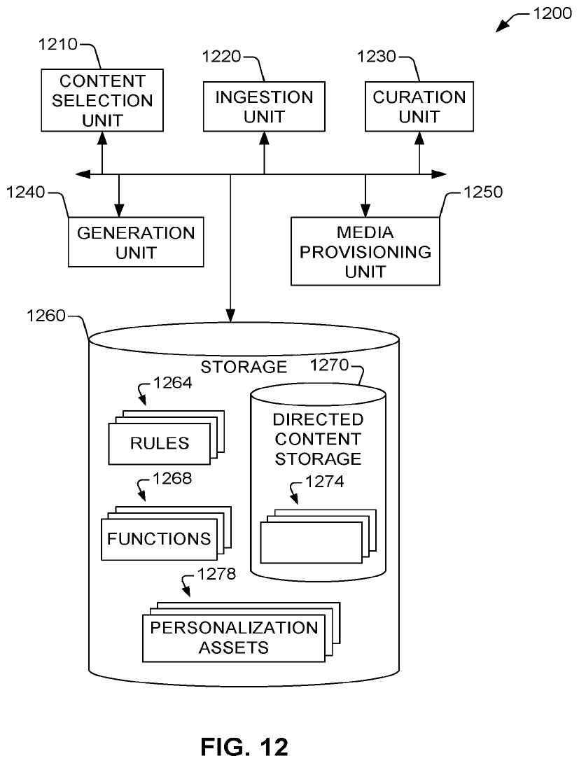

Besides the online portal product, or in some embodiments, the content management subsystem 130 (FIG. 1) can include a personalization subsystem 1200 as is illustrated in FIG. 12. The personalization subsystem 1200 can permit creating a personalized media asset that incorporates directed content. The personalization subsystem 1200 can permit, for example, generating, curating, and/or disseminating interactive webinar and video experiences and other multimedia content to distributed audience segments with relevant messaging, offers, and calls-to-action (e.g., view video, listen to podcast, signup for newsletter, attend a tradeshow, etc.).

The personalization subsystem 1200 can include a content selection unit 1210 that can identify directed content assets that can be relevant to an end-user consuming a media asset via a user device. To that end, the content selection unit 1210 can cause or otherwise direct an ingestion unit 1220 to obtain a group of directed content assets from directed content storage 1270 retaining a corpus of directed content assets 1274. In some cases, the corpus of directed content assets 1274 can be categorized according to attributes of the end-user. The attributes can include, for example, market type, market segment, geography, business size, business type, revenue, profits, and similar. Accordingly, for a particular end-user for which the personalization is being implemented, the content selection unit 1210 can cause or otherwise direct the ingestion unit 1220 to obtain directed content assets having a particular set of attributes. Simply as an illustration, the ingestion unit 1220 can obtain multiple directed content assets having the following attributes: industrial equipment, small-medium business (SMB), and U.S. Midwest.

In some cases, the ingestion unit 1220 can cause or direct a source device to present a user interface including UI elements representative of the multiple directed content assets. The UI elements can be presented according to one of various formats. As mentioned, the UI elements can be embodied in images representing respective ones of the multiple directed content assets, where those images can be presented as respective thumbnails or in a selectable carousel area within the user interface. The user interface also can include selectable UI elements that permit selecting one or several of the multiple directed content assets.

The personalization subsystem 1200 also can include a curation unit 1230 that can receive input information indicating approval of one or several directed content assets for presentation with media assets. The input information can be received from the source device that personalizes the media asset. In other cases, the curation unit 1230 can evaluate each one the multiple directed content assets obtained by the ingestion unit 1220. An evaluation that satisfies one or more defined criteria results in the directed content asset being approved for presentation with media assets.

Regardless of approval mechanism, the curation unit 1230 can then configure each one of the approved directed content asset(s) as being available for personalization. To configure an approved directed content asset in such a manner, the curation unit 1230 can add metadata to the approved directed content asset. The metadata can be indicative of approval for personalization. As mentioned, the approval and configuration represent the curation of the directed content asset(s). The ingestion unit 1220 can update a corpus of personalization assets 1278 to include directed content assets that have been curated for a particular end-user, within a storage 1260.

The personalization subsystem 1200 also can include a generation unit 1240 that can select one or several personalization assets of the personalization assets 1278 and can then incorporate the personalization asset(s) into a media asset being personalized. The personalization asset(s) can be incorporated into the media asset in numerous ways. In some cases, incorporation of a personalization asset into the media asset can include the addition of one or several overlays to the media asset. A first overlay can include notes on a product described in the media asset. The overlay can be present for a defined duration that can be less than or equal to the duration of the media asset. Simply as an illustration, for industrial equipment, the note can be a description of capacity of a mining sifter or stability features of a vibrating motor. A second overlay can include one or several links to respective documents (e.g., product whitepaper) related to the product. Further, or as another alternative, a third overlay can include a call-to-action related to the product.

Further, or in some cases, the generation unit 1240 can configure one or several functionality features to be made available during presentation of the media asset. Examples of the functionality features include translation, transcription, read-aloud, live chat, trainer/presenter scheduler, or similar. In some cases, the type and number of functionality features that are configured can be based on the respective scores as is described above. The functionality features can be retained in one or more memory elements 1268 (referred to as functions 1268).

The generation unit 1240 can generate formatting information defining presentation attributes of one or several overlays to be included in the media asset being personalized. In addition, or in some cases, the generation unit 1240 also can generate second formatting information identifying the group of functionality features to be included with the media asset.

The media provisioning unit 1250 can integrate available formatting information into the media asset as metadata. The media asset having that metadata constitutes a personalized media asset. The metadata can control at least some aspects of the personalized digital experience that includes the presentation of the media asset. The media provisioning unit 1250, in some cases, also can configure one or more platforms/channels (web, mobile web, and/or mobile application, for example) to present the media asset. In addition, or in other cases, the media provisioning unit 1250 also can configure a group of rules 1264 that control presentation of the media asset. As an example, the media provisioning unit 1250 can define a rule that dictates that directed content is presented during specific time intervals during certain days. Further, or as another example, the media provisioning unit 1250 can configure another rule that dictates that directed content is presented during a particular period. For example, the particular period can be a defined number of days after initial consumption of the media asset. As yet another example, the media provisioning unit 1250 can define yet another rule that dictates that directed content is presented a defined number of times during a particular period.

The media provisioning unit 1250 can provision the personalized media asset for presentation at a user device (e.g., one of the user devices 102) by retaining the personalized media asset in at least one of the media repositories 164 (FIG. 1) for example. As part of provisioning the personalized media asset, the media provisioning unit 1250 also can send a notification message indicative of the personalized media asset being available for presentation. The notification message can be sent to one or more of the delivery servers 162 (FIG. 1). The personalized media asset that has been provisioned can be presented at the user device in accordance with aspects described herein.

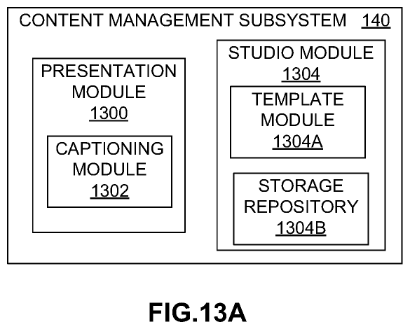

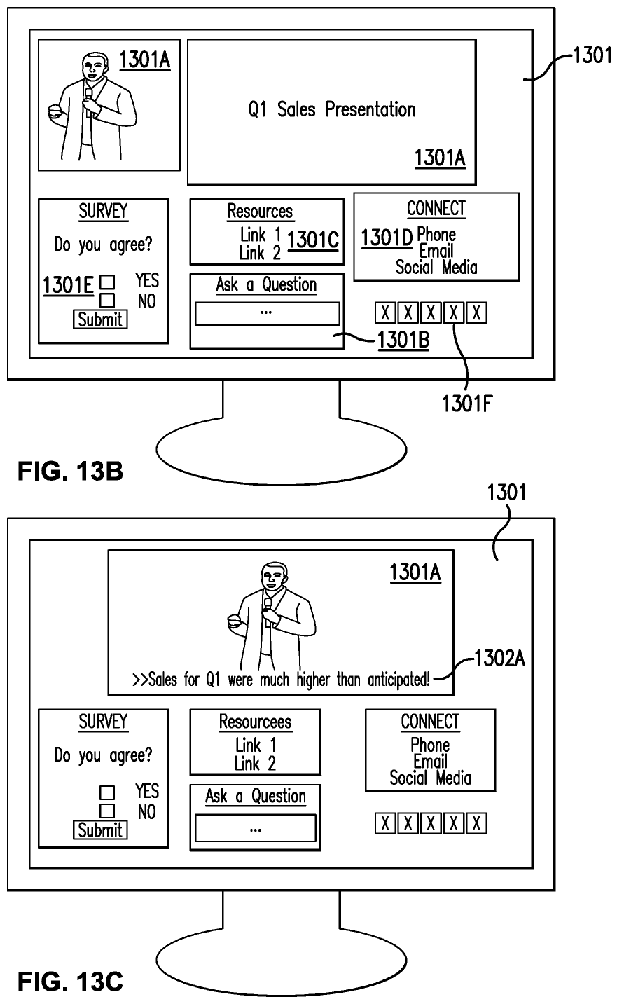

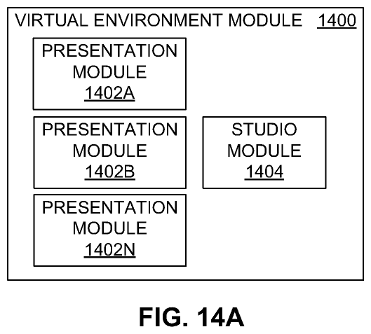

FIG. 13A shows example components of the content management subsystem 140. Digital content (e.g., the media assets 166) as described herein may be provided by a presentation module 1300 of the content management subsystem 140. For example, the media assets 166 may comprise interactive webinars. The webinars may comprise web-based presentations, livestreams, webcasts, etc. The phrases “webinar” and “communication session” may be used interchangeably herein. A communication session may comprise an entire webinar or a portion (e.g., component) of a webinar, such as a corresponding chat room/box. The presentation module 1300 may provide webinars at the user devices 102 via the client application 106. As further described herein, the webinars may be provided via a user interface(s) 1301 of the client application 106.

The webinars may comprise linear content (e.g., live, real-time content) and/or on-demand content (e.g., pre-recorded content). For example, the webinars may be livestreamed. As another example, the webinars may have been previously livestreamed and recorded. Previously-recorded webinars may be stored in the media repository 164 and accessible on-demand via the client application 106. As further described herein, a plurality of controls provided via the client application 106 may allow users of the user devices 102 to pause, fast-forward, and/or rewind previously-recorded webinars that are accessed/consumed on-demand.

As shown in FIG. 13A, the content management subsystem 140 may comprise a studio module 1304. The studio module 1304 may comprise a production environment (not shown). The production environment may comprise a plurality of tools that administrators and/or presenters of a webinar may use to record, livestream, and/or upload multimedia presentations/content for the webinar. For example, the production environment can include a drag-and-drop interface that can permit generating a media asset. In addition to that interface, or in some embodiments, the production environment can access layout defined templates, a library of stock images and/or stock video segments, or similar resources. As such, the production environment permits avoiding website or code development.

The studio module 1304 may comprise a template module 1304A. The template module 1304A may be used to customize the user experience for a webinar using a plurality of stored templates (e.g., layout templates). For example, administrators and/or presenters of a webinar may use the template module 1304A to select a template from the plurality of stored templates for the webinar. The stored templates may comprise various configurations of user interface elements, as further described below with respect to FIG. 13B. For example, each template of the plurality of stored templates may comprise a particular background, font, font size, color scheme, theme, pattern, a combination thereof, and/or the like. The studio module 1304 may comprise a storage repository 1304B that allows any customization and/or selection made within the studio module 1304 to be saved (e.g., as a template).

FIG. 13B shows an example of a user interface 1301 of an example webinar. The user interface 1301 may be generated by the presentation module 1300 and presented at the user devices 102 via the client application 106. The presentation module 1300 can cause or otherwise direct the client application 106 to present the user interface 1301. The user interface 1301 for a particular webinar may comprise a background, font, font size, color scheme, theme, pattern, a combination thereof, and/or the like. The user interface 1301 may comprise a plurality of interface elements (e.g., “widgets”) 1301A-1301F. The user interface 1301 and the plurality of interface elements 1301A-1301F may be configured for use on any computing device, mobile device, media player, etc. that supports rich web/Internet applications (e.g., HTML5, Adobe Flash™, Microsoft Silverlight™, etc.).

As shown in FIG. 13B, the user interface 1301 may comprise a media player element 1301A. The media player element 1301A may stream audio and/or video presented during a webinar. The media player element 1301A may comprise a plurality of controls (not shown) that allow users of the client application 106 to adjust a volume level, adjust a quality level (e.g., a bitrate), and/or adjust a window size. For webinars that are provided on-demand, the plurality of controls of the media player element 1301A may allow users of the client application 106 to pause, fast-forward, and/or rewind content presented via the media player element 1301A.

As another example, as shown in FIG. 13B, the user interface 1301 may comprise a Q&A element 1301B. The Q&A element 1301B may comprise a chat room/box that allows users of the client application 106 to interact with other users, administrators, and/or presenters of the webinar. The user interface 1301 may also comprise a resources element 1301C. The resources element 1301C may include a plurality of internal or external links to related content associated with the webinar, such as other webinars, videos, audio, images, documents, websites, a combination thereof, and/or the like.

The user interface 1301 may comprise a communication element 1301D. The communication element 1301D may allow users of the client application 106 to communicate with an entity associated with the webinar (e.g., a company, person, website, etc.). For example, the communication element 1301D may include links to email addresses, websites, social media accounts, telephone numbers, a combination thereof, and/or the like.

The user interface 1301 may comprise a survey/polling element 1301E. The survey/polling element 1301E may comprise a plurality of surveys and/or polls of various forms. The surveys and/or polls may allow users of the client application 106 to submit votes, provide feedback, interact with administrators and/or presenters (e.g., for a live webinar), interact with the entity associated with the webinar (e.g., a company, person, website, etc.), a combination thereof, and/or the like.

The user interface 1301 may comprise a plurality of customization elements 1301F. The plurality of customization elements 1301F may be associated with one or more customizable elements of the webinar, such as backgrounds, fonts, font sizes, color schemes, themes, patterns, combinations thereof, and/or the like. For example, the plurality of customization elements 1301F may allow the webinar to be customized via the studio module 1304. The plurality of customization elements 1301F may be customized to enhance user interaction with any of the plurality of interface elements (e.g., “widgets”) described herein. For example, the plurality of customization elements 1301F may comprise a plurality of control buttons associated with the webinar, such as playback controls (e.g., pause, FF, RWD, etc.,), internal and/or external links (e.g., to content within the webinar and/or online), communication links (e.g., email links, chat room/box links), a combination thereof, and/or the like.

Users may interact with the webinars via the user devices 102 and the client application 106. User interaction with the webinars may be monitored by the client application 106. For example, the user activity data 224 (FIG. 2) associated with the webinars provided by the presentation module 1300 may be monitored via the activity monitoring unit 220 (FIG. 2). Examples of the user activity data 224 associated with the webinars includes, but is not limited to, interaction with the user interface 1301 (e.g., one or more of the elements 1301A-1301F), interaction with the studio module 1304, a duration of a webinar consumed (e.g., streamed, played), a duration of inactivity during a webinar (e.g., inactivity indicated by the user device 102), a frequency or duration of movement (e.g., movement indicated by the user device 102), a combination thereof, and/or the like. The user activity data 224 associated with the webinars may be provided to the analytics subsystem 142 via the activity monitoring unit 220.

As shown in FIG. 13A, the presentation module 1300 may comprise a captioning module 1302. The captioning module 1302 may receive user utterance data and/or audio data of a webinar. The user utterance data may comprise one or more words spoken by a presenter(s) (e.g., speaker(s)) and/or an attendee(s) of a webinar. The audio data may comprise audio portions of any media content provided during a webinar, such as an audio track(s) of video content played during a webinar. The captioning module 1302 may convert the user utterance data and/or the audio data into closed captioning/subtitles. For example, the captioning module 1302 may comprise—or otherwise be in communication with—an automated speech recognition engine (not shown in FIG. 13A).

The automated speech recognition engine may process the user utterance data and output a transcription(s) of the one or more words spoken by the presenter(s) and/or the attendee(s) of the webinar in real-time or near real-time (e.g., for livestreamed content). Similarly, the automated speech recognition engine may process the audio data and output a transcription(s) of the audio portions of the media content provided during the webinar in real-time or near real-time (e.g., for livestreamed content). The captioning module 1302 may generate closed captioning/subtitles corresponding to the transcription(s) output by the automated speech recognition engine. The closed captioning/subtitles may be provided as an overlay 1302A of a webinar, as is shown in FIG. 13C.

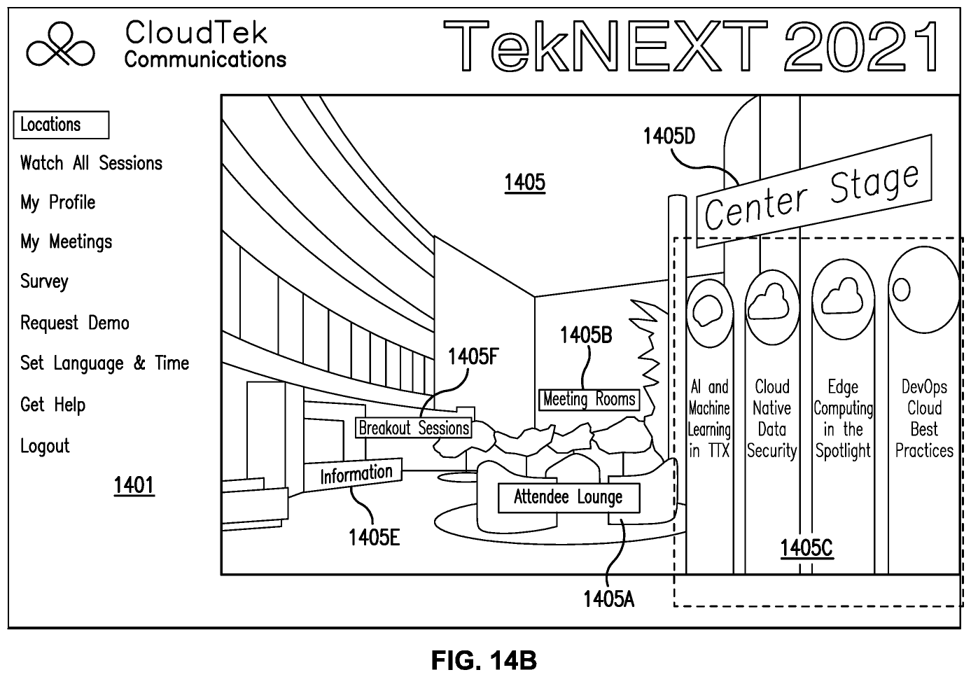

FIG. 14A shows a virtual environment module 1400. The virtual environment module 1400 may be a component of the content management subsystem 140 (FIG. 1). The virtual environment module 1400 may permit or otherwise facilitate presentation of, and be interactive with, a plurality of the media assets 166 (FIG. 1) in an interactive virtual environment 1401, as shown in FIG. 14B. For example, the virtual environment module 1400 may permit or otherwise facilitate presentation of, and be interactive with, a plurality of webinars at the user devices 102 via the client application 106 within the interactive virtual environment 1401. For example, as is described herein, the media assets 166 may comprise interactive webinars (e.g., web-based presentations, livestreams, webcasts, etc.) that may be provided via the client application 106 by the presentation module 1300 within the interactive virtual environment 1401.

As shown in FIG. 14A, the virtual environment module 1400 may comprise a plurality of presentation modules 1402A, 1402B, 1402N. Each presentation module of the plurality of presentation modules 1402A, 1402B, 1402N may comprise an individual session, instance, virtualization, etc., of the presentation module 1300. For example, the plurality of presentation modules 1402A, 1402B, 1402N may comprise a plurality of simultaneous webinars (e.g., a subset of the media assets 166) that are provided by the presentation module 1300 via the client application 106. The virtual environment module 1400 may enable users of a user device (e.g., one of the user devices 102) to interact with each webinar via the interactive virtual environment 1401 and the client application 106.

Each of the plurality of presentation modules 1402A, 1402B, 1402N may comprise a communication session/webinar, such as a chat room/box, an audio call/session, a video call/session, a combination thereof, and/or the like. As an example, and as further described herein, the interactive virtual environment 1401 may comprise a virtual conference/tradeshow, and each of the plurality of presentation modules 1402A, 1402B, 1402N may comprise a communication session that may function as a virtual “vendor booth,” “lounge,” “meeting room,” “auditorium,” etc., at the virtual conference/tradeshow. In this way, the plurality of presentation modules 1402A, 1402B, 1402N may enable users at the user devices 102 to communicate with other users and/or devices via the interactive virtual environment 1401 and the client application 106.

Users of the user devices 102 may interact with the interactive virtual environment 1401 via the client application 106. The service management subsystem 138 (FIG. 1) may administer (e.g., control) such interactions between the user devices 102 and the interactive virtual environment 1401. For example, the service management subsystem 138 may generate a session identifier (or any other suitable identifier) for each of the communication sessions (e.g., webinars)—or components thereof (e.g., chat rooms/boxes)—within the interactive virtual environment 1401. The service management subsystem 138 may use the session identifiers to ensure that only the user devices 102 associated with a particular communication session (e.g., via registration/sign-up, etc.) may interact with the particular communication session.

As described herein, the media assets 166 may comprise interactive webinars (e.g., web-based presentations, livestreams, webcasts, etc.) that may be provided via the client application 106 by the presentation module 1300 within the content management subsystem 140. The media assets 166 may comprise linear content (e.g., live, real-time content) and/or on-demand (e.g., pre-recorded content). For example, the media assets 166 may be livestreamed within the interactive virtual environment 1401 according to a schedule of a corresponding virtual conference/tradeshow (e.g., a “live” conference/tradeshow). As another example, the media assets 166 corresponding to another virtual conference/tradeshow may be pre-recorded, and the media assets 166 may be accessible via the media repository 164 on-demand via the client application 106. For virtual conferences/tradeshows that are not live or real-time (e.g., the corresponding media assets are pre-recorded), the interactive virtual environment 1401 may nevertheless allow a user(s) of a user device(s) 102 to interact with the virtual conference/tradeshow as if it were live or being held in real-time. As an example, the interactive virtual environment 1401 may allow the user(s) of the user device(s) 102 to interact with an on-demand virtual conference/tradeshow as if the user(s) were actually present when the corresponding communication sessions (e.g., webinars) were being held/recorded. In this way, the user(s) of the user device(s) 102 may interact with the on-demand virtual conference/tradeshow as an observer in simulated-real-time. The user(s) may navigate to different communication sessions of the on-demand virtual conference/tradeshow via the interactive virtual environment 1401, and the user-experience may only be limited in that certain aspects, such as chat rooms/boxes, may not be available for direct interaction. The user(s) may navigate within the on-demand virtual conference/tradeshow via the interactive virtual environment 1401 in 1:1 simulated-real-time or in compressed/shifted time. For example, the user(s) may “fast-forward” or “rewind” to different portions of the on-demand virtual conference/tradeshow via the interactive virtual environment 1401. In this way, the user(s) may be able to skip certain portions of a communication session and/or re-experience certain portions of a communication session of the on-demand virtual conference/tradeshow.

As shown in FIG. 14A, the virtual environment module 1400 may comprise a studio module 1404. The studio module 1404 may function similar to the studio module 1304 described herein. For example, the studio module 1404 may allow administrators and/or presenters of a virtual conference/tradeshow—or a session/webinar thereof—to record, livestream, and/or upload multimedia presentations/content for the virtual conference/tradeshow. The studio module 1404 may allow administrators and/or presenters of a virtual conference/tradeshow—or a session/webinar thereof—to customize the user experience using the template module 1304A and the plurality of templates (e.g., layouts) stored in the storage repository 1304B. For example, administrators and/or presenters of a virtual conference/tradeshow—or a session/webinar thereof—may use the studio module 1404 to select a template from the plurality of templates stored in the storage repository 1304B. The storage repository 1304B also can retain a library of interactivity elements, such as scheduler elements and Q&A elements that permit establishing a chat, or virtual dialog, with a presenter. The studio module 1404 may store/save any customization and/or selection made within the studio module 1404 to the storage repository 1304B.

User interaction with virtual conferences/tradeshows via the interactive virtual environment 1401, whether the virtual conferences/tradeshows are real-time or on-demand, may be monitored by the client application 106. For example, user interaction with virtual conferences/tradeshows via the interactive virtual environment 1401 may be monitored via the activity monitoring unit 220 and stored as user activity data 224. The user activity data 224 associated with the virtual conferences/tradeshows may include, as an example, interaction with the user interface 1301 (e.g., one or more of the elements 1301A-1301F) within a particular communication session/webinar. As another example, the user activity data 224 associated with the virtual conferences/tradeshows may include interaction with the studio module 1404. Further examples of the user activity data 224 associated with the virtual conferences/tradeshows include, but are/not limited to, a duration of a communication session/webinar consumed (e.g., streamed, played), a duration of inactivity during a communication session/webinar (e.g., inactivity indicated by a user device of the user devices 102), a frequency or duration of movement (e.g., movement indicated by indicated by a user device of the user devices 102), a combination thereof, and/or the like. The user activity data 224 associated with the virtual conferences/tradeshows may be provided to the analytics subsystem 142 via the activity monitoring engine 220.

FIG. 14B shows an example lobby 1405 of a virtual conference/tradeshow within the interactive virtual environment 1401. The interactive virtual environment 1401 provided via the client application 106 may enable a visual interaction, an audible interaction, and/or an emulated physical interaction between the users of the user devices 102 and areas/events within a virtual conference/tradeshow, as indicated by the lobby 1405. Emulated physical interactions may be enabled by haptic effects and/or other sensory effects at the user devices 302. Such effects can be provided by a sensory device, such as a haptic device or another type of device that causes a perceivable physical effect at a user device. For example, as shown in the lobby 1405 in FIG. 14B, the interactive virtual environment 1401 may provide the users of the user devices 102 with a rendered scene of a virtual conference/tradeshow. As discussed above, the interactive virtual environment 1401 may allow the users of the user devices 102 to interact with the virtual conference/tradeshow in real-time or on-demand. The manner in which the users of the user devices 102 interact with the virtual conference/tradeshow may correspond to capabilities of the user devices 102. For example, if a particular user device 102 is a smart phone, user interaction may be facilitated by a user interacting with a touch screen of the smart phone. As another example, if a particular user device 102 is a computer or gaming console, user interaction may be facilitated by a user via a keyboard, mouse, and/or a gaming controller. Other examples are possible as well. The user devices 102 may include additional components that enable user interaction, such as sensors, cameras, speakers, etc. The interactive virtual environment 1401 of a virtual conference/tradeshow may be presented via the client application 106 in various formats such as, for example, two-dimensional or three-dimensional visual displays (including projections), sound, haptic feedback, and/or tactile feedback. The interactive virtual environment 1401 may comprise, for example, portions using augmented reality, virtual reality, a combination thereof, and/or the like.

A user may interact with the lobby 1405 via the interactive virtual environment 1401 and the user interface(s) 1301 of the client application 106. As an example, as shown in FIG. 14B, the lobby 1405 may allow a user to navigate to a virtual attendee lounge 1405A, meeting rooms 1405B, a plurality of presentations 1405C at a virtual auditorium (“Center Stage”) 1405D, an information desk 1405E, and breakout sessions 1405F. The virtual attendee lounge 1405A, the meeting rooms 1405B, each of the plurality of presentations 1405C at the virtual auditorium 1405D, the information desk 1405D, and the breakout sessions 1405F may be facilitated by the virtual environment module 1400 and the plurality of presentation modules 1402A, 1402B, 1402N.

The presentation module 1402A may be associated with a first part of the virtual conference/tradeshow, such as the virtual attendee lounge 1405A, the presentation module 1402B may be associated with another part of the virtual conference/tradeshow, such one or more of the breakout sessions 1405F, and the presentation module 1402N may be associated with a further part of the virtual conference/tradeshow, such as one or more of the plurality of presentations 1405C in the virtual auditorium (“Center Stage”) 1405D. As an example, a user may choose to view one of the plurality of presentations 1405C. As discussed herein, the user device(s) 102 may be smart phones, in which case the user may touch an area of a screen of the smart phone displaying the particular presentation of the plurality of presentations 1405C he or she wishes to view. The presentation module 1402N may receive a request from the smart phone via the client device 106 indicating that the user wishes to view the particular presentation. The presentation module 1402N may cause the smart phone, via the client application 106, to render a user interface associated with the particular presentation, such as the user interface 1301. The user may view the particular presentation and interact therewith via the user interface in a similar manner as described herein with respect to the user interface 1301. The user interface associated with the presentation may comprise an exit option, such as a button (e.g., a customization element 1301F), which may cause the smart phone, via the client application 106, to “leave” the presentation and “return” the user to the lobby 1405. For example, the user may press on an area of the smart phone's screen displaying the exit option/button, and the presentation module 1402N may cause the smart phone, via the client application 106, to render the lobby 1405 (e.g., “returning” the user to the lobby of the virtual conference/tradeshow).

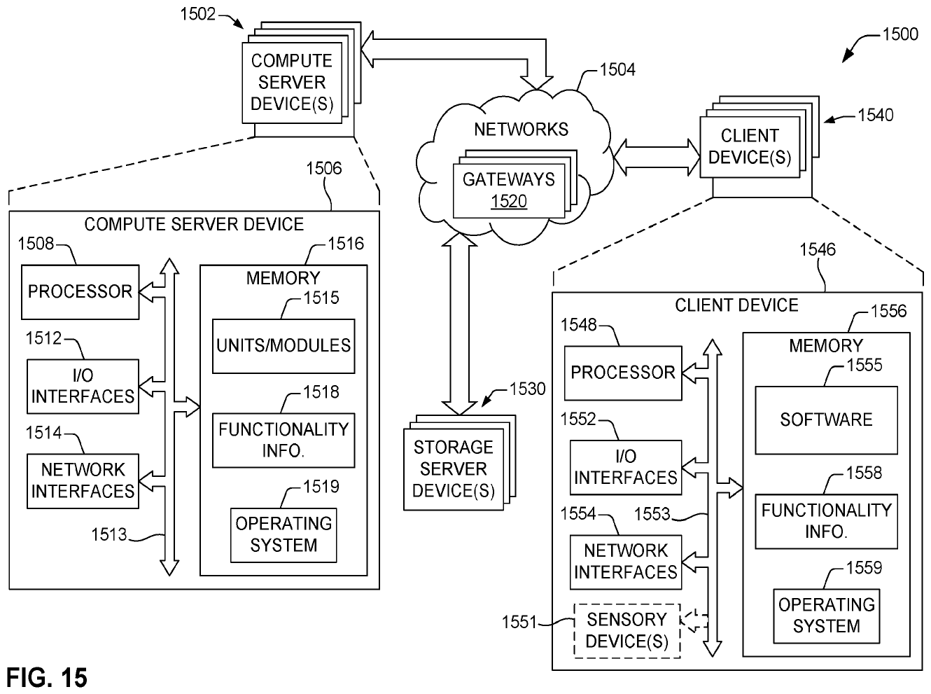

FIG. 15 illustrates an example of a computing system 1500 that can implement various functionalities of this disclosure. The computing system 1500 includes examples of multiple compute server devices 1502 mutually functionally coupled by means of one or more networks 1504, such as the Internet or any wireline or wireless connection. More specifically, the example computing system 1500 includes two types of server devices: Compute server devices 1502 and storage server devices 1530. At least a subset of the compute server devices 1502 can operate in accordance with functionality described herein in connection with consumption, evaluation, and configuration of media assets.

At least the subset of the compute server devices 1502 can be functionally coupled to one or many of the storage server devices 1530. That coupling can be direct or can be mediated by at least one of gateway devices 1520. The storage server devices 1530 include data and metadata that can be used to implement the functionality described herein in connection with the consumption, evaluation, and composition of media assets. The storage server device 1530 also can include other information in accordance with aspects described herein, such as rules; scoring models; machine-learning models; media assets; directed content assets; layout templates; functions, APIs, and/or other procedures; user profiles (e.g., user profiles 310); subscriber accounts (e.g., subscriber accounts 330); user activity data (e.g., data 244); features; combinations thereof; or the like. In addition, or in some embodiments, the storage server devices 1530 can embody, or can include, the storage subsystem 144 and/or other storage and repositories described herein.

Each one of the gateway devices 1520 can include one or many processors functionally coupled to one or many memory devices that can retain application programming interfaces (APIs) and/or other types of program code for access to the compute server devices 1502 and storage server devices 1530. Such access can be programmatic, via an appropriate function call, for example. A combination of the compute server devices 1502, the storage server devices 1530, and the gateway devices 1520 can embody, or can include, the backend platform devices 130. In addition, or in other embodiments, such a combination also can include the distribution platform devices 160 (FIG. 1).

Each one of the compute server devices 1502 can be a digital computer that, in terms of hardware architecture, can include one or more processors 1508 (generically referred to as processor 1508), one or more memory devices 1510 (generically referred to as memory 1510), input/output (I/O) interfaces 1512, and network interfaces 1514. These components (1508, 1510, 1512, and 1514) are functionally coupled via a communication interface 1513. The communication interface 1513 can be embodied in, or can include, for example, one or more bus architectures, or other wireline or wireless connections. The bus architecture(s) can be embodied in, or can include, one or more of several types of bus structures, including a memory bus or a memory controller, a peripheral bus, an accelerated graphics port, and a processor or local bus using any of a variety of bus architectures. As an illustration, such architectures can include an ISA bus, an MCA bus, an EISA bus, a VESA local bus, an AGP bus, a PCI bus, a PCI-Express bus, a PCMCIA bus, a USB, a combination thereof, or the like.

In addition, or in some embodiments, at least one of the bus architecture(s) can include an industrial bus architecture, such as an Ethernet-based industrial bus, a CAN bus, a Modbus, other types of fieldbus architectures, or the like. Further, or in yet other embodiments, the communication interface 1513 can include additional elements, which are omitted for simplicity, such as controller device(s), buffer device(s) (e.g., cache(s)), drivers, repeaters, transmitter device(s), and receiver device(s), to enable communications. Further, the communication interface 1513 may include address, control, and/or data connections to enable appropriate communications among the aforementioned components.

The processor 1508 can be a hardware device that includes processing circuitry that can execute software, particularly software stored in one or more memory devices 1516 (referred to as memory 1516). In addition, or as an alternative, the processing circuitry can execute defined operations besides those operations defined by software. The processor 1508 can be any custom-made or commercially available processor, a CPU, a GPU, a TPU, an auxiliary processor among several processors associated with the compute server device 1506, a semiconductor-based microprocessor (in the form of a microchip or chipset), or generally any device for executing software instructions or performing defined operations. As an illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory.

When the compute server device 1506 is in operation, the processor 1508 can be configured to execute software stored within the memory 1516, for example, in order to communicate data to and from the memory 1516, and to generally control operations of the compute server device 1506 according to the software and aspects of this disclosure.

The I/O interfaces 1512 can be used to receive input data from and/or for providing system output to one or more devices or components. Input data can be provided via, for example, a keyboard, a touchscreen display device, a microphone, and/or a mouse. System output can be provided, for example, via the touchscreen display device or another type of display device. The I/O interfaces 1512 can include, for example, a serial port, a parallel port, a Small Computer System Interface (SCSI), an infrared (IR) interface, a radiofrequency (RF) interface, and/or a universal serial bus (USB) interface.

The network interfaces 1514 can be used to transmit and receive data, metadata, and/or signaling from one, some, or all of the compute server device 1502 that are external to the compute server device 1506 on one or more of the network(s) 1504. The network interfaces 1514 also can be used to transmit and receive data, metadata, and/or signaling from other types of apparatuses that are external to the compute server device 1506, on one or more of the network(s) 1504. The network interface 1514 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi), or any other suitable network interface device. The network interfaces 1514 may include address, control, and/or data connections to enable appropriate communications on the network(s) 1504.

The memory 1516 can include any one or combination of volatile memory elements (e.g., random access memory (RAM, such as DRAM, SRAM, SDRAM, etc.)) and non-volatile memory elements (e.g., ROM, hard drive, tape, CDROM, DVDROM, etc.). The memory 1516 also may incorporate electronic, magnetic, optical, solid-state, and/or other types of storage media. In some embodiments, the compute server device 1506 can access one or many of the storage server devices 1530.

Software that is retained in the memory 1516 may include one or more software components, each of which can include, for example, an ordered listing of executable instructions for implementing logical functions in accordance with aspects of this disclosure. As is illustrated in FIG. 15, the software in the memory 1516 of the compute server device 1506 can include multiple units/modules 1515 and an O/S 1519. The O/S 1518 essentially controls the execution of other computer programs and provides, amongst other functions, scheduling, input-output control, file and data management, memory management, and communication control and related services.

The memory 1516 also retains functionality information 1518 (e.g., data, metadata, or a combination of both) that, in combination with the units/modules 1515, can provide the functionality described herein in connection with at least some of the subsystems 136 (FIG. 1).

Application programs and other executable program components, such as the O/S 1518, are illustrated herein as discrete blocks, although it is recognized that such programs and components can reside at various times in different storage components of the compute server device 1506. An implementation of the units/modules 1515 can be stored on or transmitted across some form of computer-readable storage media. In an example implementation, the one or more units/modules 1515 can include multiple subsystems that form a software architecture that includes the service management subsystem 138, the content management subsystem 140, and the analytics subsystem 142. In each one of the compute server nodes 1502, the subsystems of such a software architecture can be executed, by the processor 1508, for example, to provide the various functionalities described herein in accordance with one or more embodiments of this disclosure. In some embodiments the units/modules 1515 retained within respective ones of a group of compute server device(s) 1502 can correspond to a particular subsystem of the subsystems 136 (FIG. 1), and units/modules 1515 retained within respective ones of another group of compute server device(s) 1502 can correspond to another particular subsystem of the subsystems 136 (FIG. 1).

The computing system 1500 also can include one or more client devices 1540. Each one of the client devices 1540 can access at least some of the functionality described herein by means of a gateway of the gateways 1520 and a client application (e.g., the client application 106 (FIG. 1). Each one of the client devices is a computing device having the general structure illustrated with reference to a client device 1546 and described hereinafter.

The client device 1546 can include one or more memory devices 1546 (referred to as memory 1546). The memory 1546 can have processor-accessible instructions encoded thereon. The processor-accessible instructions can include, for example, program instructions that are computer readable and computer-executable.

The client device 1546 also can include one or multiple input/output (I/O) interfaces 1552 and network interfaces 1554. A communication interface 1553 can functionally couple two or more of those functional elements of the client device 1546. The communication interface 1553 can include one or more of several types of bus architectures, including a memory bus or memory controller, a peripheral bus, an accelerated graphics port, and a processor or local bus using any of a variety of bus architectures. As an example, such architectures can comprise an ISA bus, an MCA bus, an EISA bus, a VESA local bus, an AGP bus, and a PCI, a PCI-Express bus, a PCMCIA bus, a USB bus, or the like.

Functionality of the client device 1546 can be configured by computer-executable instructions (e.g., program instructions or program modules) that can be executed by at least one of the one or more processors 1548. A subset of the computer-executable instructions can embody a software application, such as the client application 106 or another type of software application (e.g., a presentation application, for example). Such a subset can be arranged in a group of software components. A software component of the group of software components can include computer code, routines, objects, components, data structures (e.g., metadata objects, data object, control objects), a combination thereof, or the like, that can be configured (e.g., programmed) to perform a particular action or implement particular abstract data types in response to execution by the at least one processor.

Thus, the software application can be built (e.g., linked and compiled) and retained in processor-executable form within the memory 1555 or another type of machine-accessible non-transitory storage media. The software application in processor-executable form, for example, can render the client device 1546 a particular machine for consuming media assets, evaluating media assets, and/or configuring media assets as is described herein, among other functional purposes. The group of built software components that constitute the processor-executable version of the software application can be accessed, individually or in a particular combination, and executed by at least one of the processor(s) 1548. In response to execution, the software application can provide functionality described herein in connection with consumption, evaluation, and/or composition of a media asset. Accordingly, execution of the group of built software components retained in one or more memory devices 1556 (referred to as memory 1556) can cause the client device 1546 to operate in accordance with aspects described herein.

Data and processor-accessible instructions associated with specific functionality of the client device 1546 can be retained in the memory 1556, within functionality information 1558. At least a portion of such data and at least a subset of those processor-accessible instructions can permit consuming, evaluating, and/or composing a media asset in accordance with aspects described herein. In one aspect, the processor-accessible instructions can embody any number of components (such as program instructions and/or program modules) that provide specific functionality in response to execution by at least one of the processor(s) 1548. In the subject specification and annexed drawings, memory elements are illustrated as discrete blocks; however, such memory elements and related processor-accessible instructions and data can reside at various times in different storage elements (registers, files, memory addresses, etc.; not shown) in the memory 1556.

The functionality information 1558 can include data a variety of data, metadata, or both, associated with consumption, evaluation, and/or composition of a media asset in accordance with aspects described herein.

Memory 1556 can be embodied in a variety of computer-readable media. Example of computer-readable media can be any available media that is accessible by a processor in a computing device (such as one processor of the processor(s) 1548) and comprises, for example volatile media, non-volatile media, removable media, non-removable media, or a combination the foregoing media. As an example, computer-readable media can comprise “computer storage media,” or “computer-readable storage media,” and “communications media.” Such storage media can be non-transitory storage media. “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be utilized to store the desired information and which can be accessed by a computer or a processor therein or functionally coupled thereto.

Memory 1556 can comprise computer-readable non-transitory storage media in the form of volatile memory, such as RAM, EEPROM, and the like, or non-volatile memory such as ROM. In one aspect, memory 1556 can be partitioned into a system memory (not shown) that can contain data and/or program modules that enable essential operation and control of the computing device 1546. Such program modules can be implemented (e.g., compiled and stored) in memory elements 1559 (referred to as operating system 1559) whereas such data can be system data that is retained in within system data storage (not depicted in FIG. 15). The operating system 1559 and system data storage can be immediately accessible to and/or are presently operated on by at least one processor of the processor(s) 1548. The operating system 1559 embodies an operating system for the client device 1546. Specific implementation of such O/S can depend in part on architectural complexity of the client device 1546. Higher complexity affords higher-level O/Ss. Example operating systems can include iOS, Android, Windows operating system, and substantially any operating system for a mobile computing device.

Memory 1556 can comprise other removable/non-removable, volatile/non-volatile computer-readable non-transitory storage media. As an example, memory 1556 can include a mass storage unit (not shown) which can provide non-volatile storage of computer code, computer readable instructions, data structures, program modules, and other data for the client device 1546. A specific implementation of such mass storage unit (not shown) can depend on desired form factor of and space available for integration into the client device 1546. For suitable form factors and sizes of the client device 1546, the mass storage unit (not shown) can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), or the like.

In general, a processor of the one or multiple processors 1548 can refer to any computing processing unit or processing device comprising a single-core processor, a single-core processor with software multithread execution capability, multi-core processors, multi-core processors with software multithread execution capability, multi-core processors with hardware multithread technology, parallel platforms, and parallel platforms with distributed shared memory (e.g., a cache). In addition or in the alternative, a processor of the group of one or multiple processor 1548 can refer to an integrated circuit with dedicated functionality, such as an ASIC, a DSP, a FPGA, a CPLD, a discrete gate or transistor logic, discrete hardware components, or any combination thereof designed to perform the functions described herein. In one aspect, processors referred to herein can exploit nano-scale architectures such as, molecular and quantum-dot based transistors, switches and gates, in order to optimize space usage (e.g., improve form factor) or enhance performance of the computing devices that can implement the various aspects of the disclosure. In another aspect, the one or multiple processors 1548 can be implemented as a combination of computing processing units.

The client device can include or can be functionally coupled to a display device (not depicted in FIG. 15) that can display the various user interfaces in connection with consumption, evaluation, and/or configuration of media assets, as is provided, at least in part, by the software application contained in the software 1555.

The one or multiple I/O interfaces 1552 can functionally couple (e.g., communicatively couple) the client device 1546 to another functional element (a component, a unit, server, gateway node, repository, a device, or similar). Functionality of the client device 1546 that is associated with data I/O or signaling I/O can be accomplished in response to execution, by a processor of the processor(s) 1548, of at least one I/O interface that can be retained in the memory 1556. In some embodiments, the at least one I/O interface embodies an application programming interface (API) that permit exchange of data or signaling, or both, via an I/O interface. In some embodiments, the one or more I/O interfaces 1552 can include at least one port that can permit connection of the client device 1546 to another other device or functional element. In one or more scenarios, the at least one port can include one or more of a parallel port (e.g., GPIB, IEEE-1284), a serial port (e.g., RS-232, universal serial bus (USB), FireWire or IEEE-1394), an Ethernet port, a V.35 port, a Small Computer System Interface (SCSI) port, or the like.

The at least one I/O interface of the one or more I/O interfaces 1552 can enable delivery of output (e.g., output data or output signaling, or both) to such a device or functional element. Such output can represent an outcome or a specific action of one or more actions described herein, such as action(s) performed in the example methods described herein.

The client device 1546 can, optionally, include one or more sensory devices 1551 that can provide sensory effects corresponding to digital content pertaining to a media asset (e.g., a video or a webinar). As mentioned, the sensory effects can include haptic effects and other types of physical effects that can supplement the consumption of the media asset. In cases where the digital content pertaining to the media asset includes metadata defining sensory effects, the client device 1546 (via execution of the client application included in the software 1555, for example) can cause at least one of the sensory device(s) 1551 to implement at least a first haptic effect of a group of haptic effects during consumption of the media asset.

Although not shown in FIG. 15, each one of the compute server device 1506 and the client device 1546 can include a respective battery that can power components or functional elements within each of those devices. The battery can be rechargeable, and can be formed by stacking active elements (e.g., cathode, anode, separator material, and electrolyte) or a winding a multi-layered roll of such elements. In addition to the battery, each one of the compute server device 1506 and the client device 1546 can include one or more transformers (not depicted) and/or other circuitry (not depicted) to achieve a power level suitable for the respective operation of the compute server device 1506 and the client device 1546 and components, functional elements, and related circuitry within each of those devices.

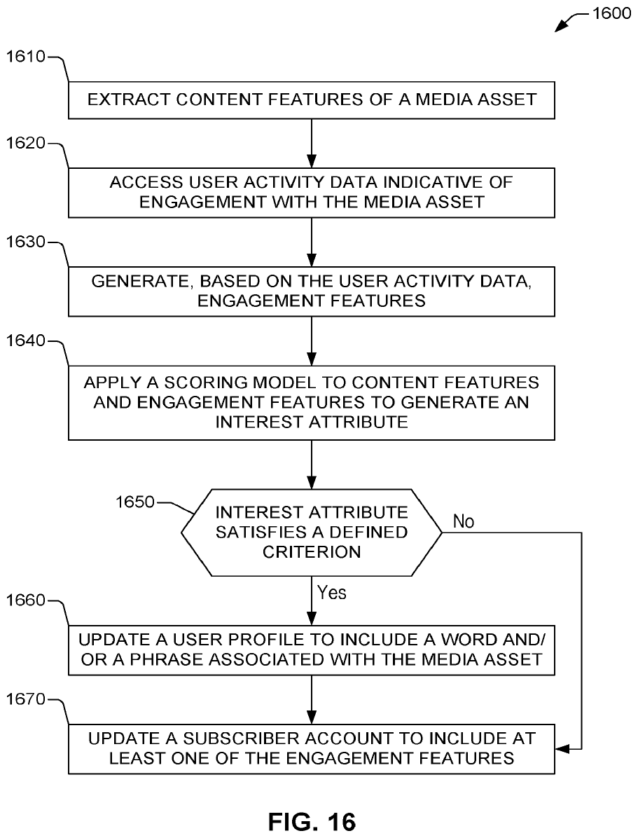

In view of the aspects described herein, example methods that may be implemented in accordance with the disclosure can be better appreciated with reference, for example, to the flowcharts in FIGS. 16-21. For purposes of simplicity of explanation, the example method disclosed herein is presented and described as a series of blocks (with each block representing an action or an operation in a method, for example). However, it is to be understood and appreciated that the disclosed method is not limited by the order of blocks and associated actions or operations, as some blocks may occur in different orders and/or concurrently with other blocks from those that are shown and described herein. For example, the various methods in accordance with this disclosure may be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods, including the example methods shown in FIGS. 16-21, can be implemented in combination with each other.

FIG. 16 shows a flowchart of an example method 1600 for generation of first-person insight, in accordance with one or more embodiments of this disclosure. A computing device or a computing system of computing devices can implement the example method 1600 in its entirety or in part. To that end, each one of the computing devices includes computing resources that can implement at least one of the blocks included in the example method 1600. The computing resources comprise, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

In some embodiments, the computing system can include at least some of the backend platform devices 130, and thus, can host at least one of the subsystems 136. In addition, or in other embodiments, the computing system also can include at least some of the distribution platform devices 160. In one example, the computing system can be embodied in the computing system 1500 described herein.

At block 1610, the computing system can extract content features of a media asset.

At block 1620, the computing system can access user activity data (e.g., user activity data 224 (FIG. 2)) indicative of engagement with the media asset. In some cases, the computing system can access the user activity data periodically or according to a defined schedule.

At block 1630, the computing system can generate, based on the user activity data, engagement features. The engagement features can be generated at defined times. The defines times can coincide with the times at which the user activity data is accessed; that is, the engagement features can be generated as the user activity data becomes available to the computing system. In addition, or in some cases, the define times can be after the times at which the user activity data is accessed. In other words, those defined time can establish update times for user profile(s) and/or subscriber account(s).

At block 1640, the computing system can apply a scoring model to content features and engagement features to generate an interest attribute. The interest attribute can be a score (e.g., a numeric value), in some cases. The scoring model can be one of the scoring models 248 (FIG. 2) or one of the ML models 280 (FIG. 2).

At block 1650, the computing system can determine if the interest attribute satisfies a defined criterion. The criterion can include a threshold value, and can dictate that a particular interest attribute must be equal to or greater than the threshold value. As such, in some instances, the computing system can determine that the interest attribute satisfies the defined criterion, e.g., the interest attribute is equal to or greater than the threshold value. As a result, the flow of the example method 1600 can directed to block 1660, where the computing system can update a user profile (e.g., one of user profiles 310 (FIG. 3A) to include a word and/or a phrase associated with the media asset. In other instances, the computing system can determine that the interest attribute does not satisfy the defined criterion. In such instances (“No” branch), the flow of the example method 1600 can be directed to block 1670, where the computing system can update a subscriber account to include at least one of the engagement features. The subscriber account can be one of the subscriber accounts 330 (FIG. 3A). In some cases, the subscriber account can include, or can be associated with, the user profile that has been updated at block 1660.

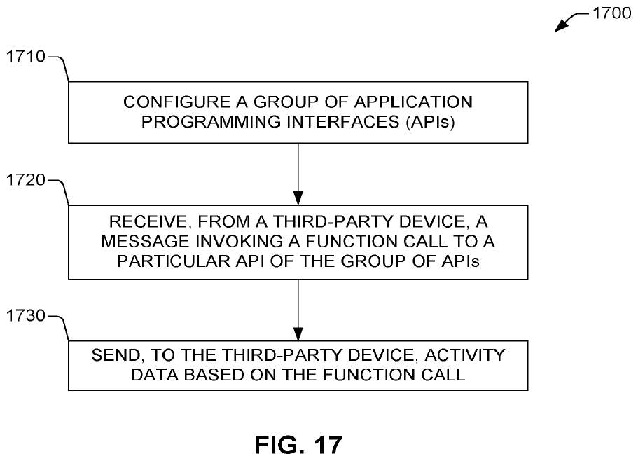

FIG. 17 shows a flowchart of an example method 1700 for providing data to third-party subsystems, in accordance with one or more embodiments of this disclosure. A computing device or a computing system of computing devices can implement the example method 1700 in its entirety or in part. To that end, each one of the computing devices includes computing resources that can implement at least one of the blocks included in the example method 1700. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

In some embodiments, the computing system can include at least some of the backend platform devices 130, and thus, can host at least one of the subsystems 136. In addition, or in other embodiments, the computing system also can include at least some of the distribution platform devices 160. In one example, the computing system can be embodied in the computing system 1500 described herein.

At block 1710, the computing system can configure a group of one or more APIs (e.g., RESTful APIs, for example). Configuring the group of one or more APIs can include exposing the API(s).

At block 1720, the computing system can receive, from a third-party device, a message invoking a function call to a particular API of the group of one or more APIs. The third-party device can host a third-party application. As is described herein, examples of the third-party application include a sales application, a marketing automation application, a CRM application, a BI application, and a marketing automation application. Such a message can be received from the third-party application while in execution. Execution of the function call can result in particular activity data (e.g., a portion of the activity data 244 (FIG. 2)).

At block 1730, the computing system can send, to the third-party device, the activity based on the function call.

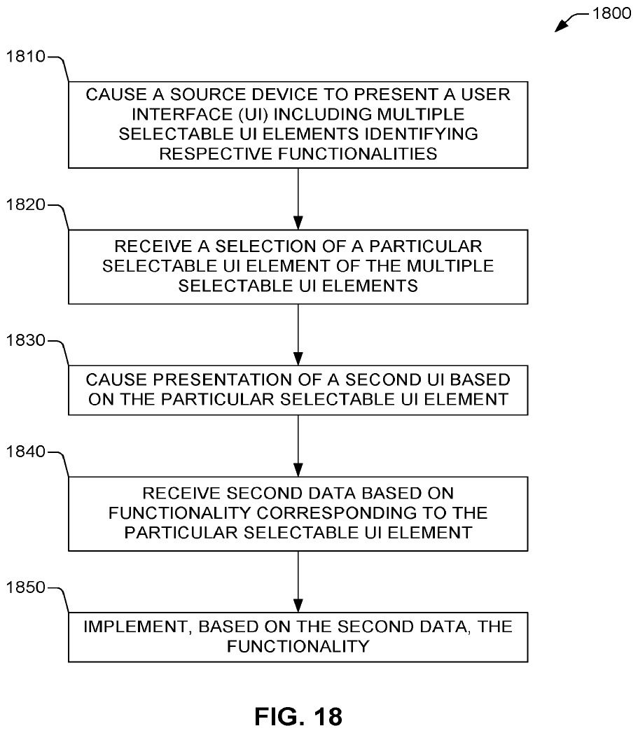

FIG. 18 shows a flowchart of an example method 1800 for accessing functionality to access and configure media assets, in accordance with one or more embodiments of this disclosure. A computing device or a computing system of computing devices can implement the example method 1800 in its entirety or in part. To that end, each one of the computing devices includes computing resources that can implement at least one of the blocks included in the example method 1800. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

In some embodiments, the computing system can include at least some of the backend platform devices 130, and thus, can host at least one of the subsystems 136. In addition, or in other embodiments, the computing system also can include at least some of the distribution platform devices 160. In one example, the computing system can be embodied in the computing system 1500 described herein.

At block 1810, the computing system can cause a source device to present a user interface (UI) including multiple selectable UI elements identifying respective functionalities.

At block 1820, the computing system can receive a selection of a particular selectable UI element of the multiple selectable UI elements.

At block 1830, the computing system can cause presentation of a second UI based on the particular selectable UI element.

At block 1840, the computing system can receive second data based on functionality corresponding to the particular selectable UI element.

At block 1850, the computing system can implement, based on the second data, the functionality.

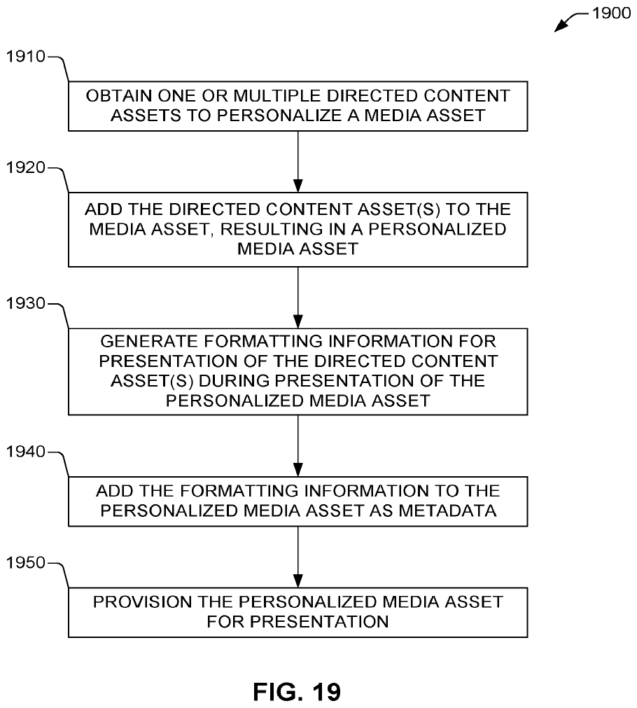

FIG. 19 shows a flowchart of an example method 1900 for accessing functionality to access and configure media assets, in accordance with one or more embodiments of this disclosure. A computing device or a computing system of computing devices can implement the example method 1900 in its entirety or in part. To that end, each one of the computing devices includes computing resources that can implement at least one of the blocks included in the example method 1900. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

In some embodiments, the computing system can include at least some of the backend platform devices 130, and thus, can host at least one of the subsystems 136. In addition, or in other embodiments, the computing system also can include at least some of the distribution platform devices 160. In one example, the computing system can be embodied in the computing system 1500 described herein.

At block 1910, the computing system can obtain one or multiple directed content assets to personalize a media asset.

At block 1920, the computing system can add the directed content asset(s) to the media asset, resulting in a personalized media asset.

At block 1930, the computing system can generate formatting information for presentation of the directed content asset(s) during presentation of the personalized media asset.

At block 1940, the computing system can add the formatting information to the personalized media asset as metadata.

At block 1950, the computing system can provision the personalized media asset for presentation. Provisioning the personalized media asset can include retaining the personalized media asset in at least one of the media repositories 164 (FIG. 1).

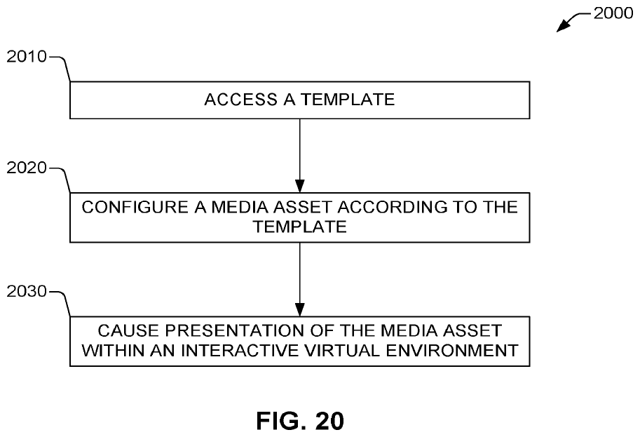

FIG. 20 shows a flowchart of an example method 2000 for accessing media assets within an interactive environment, in accordance with one or more embodiments of this disclosure. A computing device or a computing system of computing devices can implement the example method 2000 in its entirety or in part. To that end, each one of the computing devices includes computing resources that can implement at least one of the blocks included in the example method 2000. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

In some embodiments, the computing system can include at least some of the backend platform devices 130, and thus, can host at least one of the subsystems 136. In addition, or in other embodiments, the computing system also can include at least some of the distribution platform devices 160. In one example, the computing system can be embodied in the computing system 1500 described herein.

At block 2010, the computing system can access a template. The template can define a configuration of interface elements. Specifically, the template can define an arrangement of interface elements, a number of interface elements, or respective functionalities for the interface element(s), or a combination of the foregoing. More specifically, the template includes a media player element and, in some cases, one or more other interface elements.

At block 2020, the computing system can configure a media asset according to the template.

At block 2030, the computing system can cause presentation of the media asset within an interactive virtual environment (e.g., interactive virtual environment 1401 (FIG. 14B)).

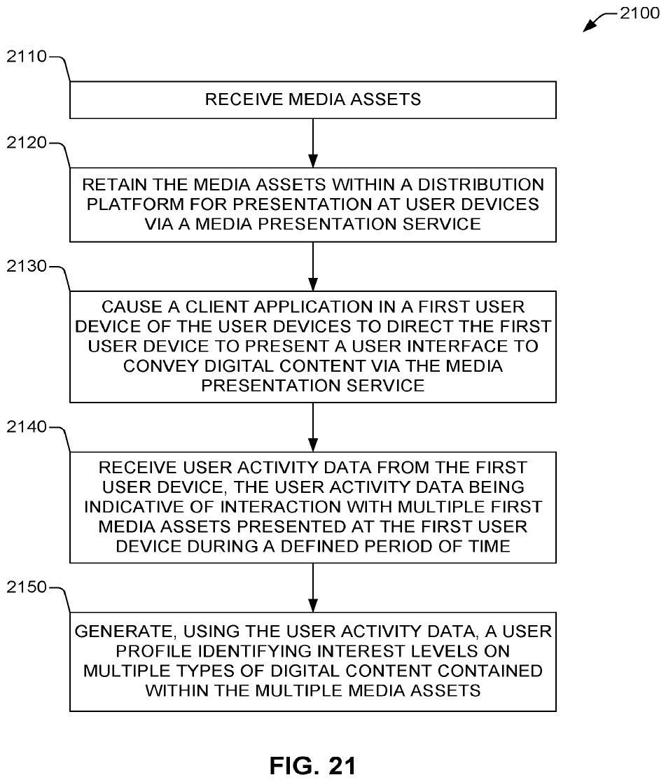

FIG. 21 shows a flowchart of an example method 2100 for accessing media assets within an interactive environment, in accordance with one or more embodiments of this disclosure. A computing device or a computing system of computing devices can implement the example method 2000 in its entirety or in part. To that end, each one of the computing devices includes computing resources that can implement at least one of the blocks included in the example method 2100. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

In some embodiments, the computing system can include at least some of the backend platform devices 130, and thus, can host at least one of the subsystems 136. In addition, or in other embodiments, the computing system also can include at least some of the distribution platform devices 160. In one example, the computing system can be embodied in the computing system 1500 described herein.

At block 2110, the computing system can receive media assets. The media assets can be received from one or more source devices via a source gateway. For example, the source device(s) can be included in the source devices 150 (FIG. 1) and the source gateway can be embodied in the source gateway 146 (FIG. 1).

At block 2120, the computing system can retain the media assets within a distribution platform for presentation at user devices via a media presentation service. The user devices (e.g., user devices 102 (FIG. 1) can be remotely located relative to the computing system. In some cases, the distribution platform can be formed by the distribution platform devices 160 (FIG. 1), and the media assets can be retained within one or more of the media repositories 164 (FIG. 1).

At block 2130, the computing system can cause a client application in a first user device of the user devices to direct the first user device to present a user interface to convey digital content. The digital content can include a particular media asset of the media assets retained in the distribution platform. The user interface can include multiple UI elements and a media player element that conveys the digital content. At least one of the multiple UI elements can control interaction with the conveyed digital content. The client application (e.g., application 106 (FIG. 1)) can be configured to access the media presentation service.

At block 2140, the computing system can receive user activity data from the first user device, the user activity data being indicative of interaction with multiple first media assets presented at the first user device during a defined period of time. In some cases, the user activity data can be received upon such data becomes available at the user device during the defined period of time. In addition, or in other cases, the user activity data can be received in batches, at defined instants (e.g., periodically, according to schedule, or in response to a defined condition being satisfied). The first media assets can be included in the media assets retained in the distribution platform. The user activity data can include the user activity data 224 (FIG. 2), for example.

At block 2150, the computing system can generate, using the user activity data, a user profile identifying interest levels on multiple types of digital content contained within the multiple media assets. The user profile corresponds to a subscriber account of the media presentation service, and, thus, the interest levels also correspond to the subscriber account.

Although not illustrated in FIG. 21, in some embodiments, the example method 2100 can include accessing a third-party computing subsystem comprising third-party applications to manage subscriber accounts of the media presentation service. As is described herein, the third-party computing subsystem can be accessed via one or more APIs. The third-party computing subsystem can be remotely located relative to the computing system. For example, the third-party computing subsystem can be one of the third-party subsystems 610 (FIG. 6).

Further, in some embodiments, the computing system that implements the example method 2100 can leverage a library of machine-learning models (e.g., ML models 280 (FIG. 2) to generate, as part of the example method 2100, a personalized set of access functionalities by applying a first machine-learning model of the library of machine-learning models to the user activity data. A first access functionality of the personalized set of access functionalities can provides a first type of interaction with the particular media asset. A second access functionality of the personalized set of access functionalities provides a second type of interaction with the particular media asset.

The computing system that implements the example method 2100 can further leverage the library of machine-learning models to provide additional functionality as part of the example method 2100. For example, the computing system can generate predictions of engagement levels for prospective subscriber accounts of the media presentation service by applying a second machine-learning model of the library of machine-learning models to registration data indicative of registrations to an event. In addition, or in some cases, the computing system can generate predictions of load conditions of the computing system by applying a third machine-learning model library of machine-learning models to feature vectors comprising at least one of a first feature defining a number of scheduled events, a second feature defining a number of registrants for each timeslot of a presentation, a first categorical variable for the hour of the day for the presentation; or a second categorical variable for day of the week for the presentation.

Numerous other embodiments emerge from the foregoing detailed description and annexed drawings. For instance, an Example 1 of those numerous embodiments includes a computing system, comprising: at least one processor; and at least one memory device having computer-executable instructions stored thereon that, in response to execution by the at least one processor, cause the computing system to: receive media assets from one or more source devices via a source gateway; retain the media assets within a distribution platform for presentation at user devices via a media presentation service, the user devices being remotely located relative to the computing system; cause a client application in a first user device of the user devices to direct the first user device to present a user interface having multiple interface elements and a media player element to convey digital content comprising a particular media asset of the media assets, the client application being configured to access the media presentation service; receive user activity data from the first user device during, the activity data identifying interaction with multiple second media assets of the media assets presented at the first user device during a defined period of time; generate, using the user activity data, a user profile for the first user device, the user profile identifying interest levels of the first user device on multiple types of digital content contained within the multiple media assets; access, via one or more application programming interfaces (APIs), a third-party computing subsystem remotely located relative to the computing system, the third-party computing subsystem comprising third-party applications to manage subscriber accounts of the media presentation service.

An Example 2 of the numerous embodiments includes the computing system of Example 1 and further includes a library of machine-learning models, and the at least one memory device having further computer-executable instructions stored thereon that, in response to execution by the at least one processor, further cause the computing system to generate a personalized set of access functionalities by applying a first machine-learning model of the machine-learning models to the user activity data; where a first access functionality of the personalized set of access functionalities provides a first type of interaction with the particular media asset; and where a second access functionality of the personalized set of access functionalities provides a second type of interaction with the particular media asset.

An Example 3 of the numerous embodiments includes the computing system of Example 2, where the personalized set of access functionalities comprises at least one of real-time translation, real-time transcription in a defined language; access to a document mentioned in the particular media asset; detection of haptic capable device and provisioning of four-dimensional (4D) experience during presentation of the particular media asset; a share function to forward information related to the particular media asset to a defined set of recipient devices; access to recommended content; or messaging functionality to send a message having a link to cited, recommended, or curated content related to the particular media asset; a scheduler functionality that prompts to add invites, adds invites, or sends invites for, a live presentation related to the particular media asset.

An Example 4 of the numerous embodiments includes the computing system of any one of Example 2 or Example 3, the at least one memory device having further computer-executable instructions stored thereon that, in response to execution by the at least one processor, further cause the computing system to: generate predictions of engagement levels for prospective subscriber accounts of the media presentation service by applying a second machine-learning model of the machine-learning models to registrations to an event; and generate predictions of load conditions of the computing system by applying a third machine-learning model to feature vectors comprising at least one of a first feature defining a number of scheduled events, a second feature defining a number of registrants for each timeslot of a presentation, a first categorical variable for the hour of the day for the presentation; or a second categorical variable for day of the week for the presentation.

An Example 5 of the numerous embodiments includes the computing system of any one of Example 1 to Example 4, where the accessing, via the one or more APIs, the third-party computing subsystem comprises exchanging data between a second gateway of the computing system and at least one of the third-party applications.

An Example 6 of the numerous embodiments includes the computing system of Example 5, where the third-party application comprise one or more of a sales application, a marketing automation application, a customer relationship management (CRM) application, a business intelligence (BI) application, or a marketing automation application.

An Example 7 of the numerous embodiments includes the computing system of any one of Example 1 to Example 6, the at least one memory device having further computer-executable instructions stored thereon that, in response to execution by the at least one processor, further cause the computing system to provide a user interface to access one or more functionalities to supply a second particular media asset of the media assets.

An Example 8 of the numerous embodiments includes the computing system of Example 7, where the one or more functionalities comprise a search functionality, a branding functionality, a layout selection functionality, a curation functionality, and a publication functionality.

An Example 9 of the numerous embodiments includes the computing system of any one of Example 1 to Example 8, the at least one memory device having further computer-executable instructions stored thereon that, in response to execution by the at least one processor, further cause the computing system to supply a third particular media asset comprising defined digital content including at least one of directed content or indicia defining a call-to-action.

An Example 10 of the numerous embodiments includes the computing system of Example 9, where supplying the third particular media asset to the first user device comprises causing the client application to direct the first user device to present the defined digital content as one or more overlays on the third particular media asset.

An Example 11 of the numerous embodiments includes a computer-implemented method comprising receiving media assets from one or more source devices via a source gateway; retaining the media assets within a distribution platform for presentation at user devices via a media presentation service, the user devices being remotely located relative to the computing system; causing a client application in a first user device of the user devices to direct the first user device to present a user interface having multiple interface elements and a media player element to convey digital content comprising a particular media asset of the media assets, the client application being configured to access the media presentation service; receiving user activity data from the first user device, the user activity data identifying interaction with multiple second media assets of the media assets presented at the first user device during a defined period of time; and generating a user profile for the first user device using the activity data, the user profile identifying interest levels of the first user device on multiple types of digital content contained within the multiple media assets.

An Example 12 of the numerous embodiments includes the computer-implemented method of Example 11 and further includes a library of machine-learning models and also includes generating a personalized set of access functionalities by applying a first machine-learning model of the machine-learning models to the user activity data; where a first access functionality of the personalized set of access functionalities provides a first type of interaction with the particular media asset; and where a second access functionality of the personalized set of access functionalities provides a second type of interaction with the particular media asset.

An Example 13 of the numerous embodiments includes the computer-implemented method of Example 12, where the personalized set of access functionalities comprises at least one of real-time translation, real-time transcription in a defined language; access to a document mentioned in the particular media asset; detection of haptic capable device and provisioning of four-dimensional (4D) experience during presentation of the particular media asset; a share function to forward information related to the particular media asset to a defined set of recipient devices; access to recommended content; or messaging functionality to send a message having a link to cited, recommended, or curated content related to the particular media asset; a scheduler functionality that prompts to add invites, adds invites, or sends invites for, a live presentation related to the particular media asset.

An Example 14 of the numerous embodiments includes the computer-implemented method of any one of Example 11 or Example 12 and further includes generating predictions of engagement levels for prospective subscriber accounts of the media presentation service by applying a second machine-learning model of the machine-learning models to registrations to an event; and generating predictions of load conditions of the computing system by applying a third machine-learning model to feature vectors comprising at least one of a first feature defining a number of scheduled events, a second feature defining a number of registrants for each timeslot of a presentation, a first categorical variable for the hour of the day for the presentation; or a second categorical variable for day of the week for the presentation.

An Example 15 of the numerous embodiments includes the computer-implemented method any one of Example 11 to Example 14 and further includes accessing, via one or more application programming interfaces (APIs), a third-party computing subsystem remotely located relative to the computing system, the third-party computing subsystem comprising third-party applications to manage subscriber accounts of the media presentation service.

An Example 16 of the numerous embodiments includes the computer-implemented method of Example 15, where the accessing, via the one or more APIs, the third-party computing subsystem comprises exchanging data between a second gateway of the computing system and at least one of the third-party applications.

An Example 17 of the numerous embodiments includes the computer-implemented method of Example 16, where the third-party application comprise one or more of a sales application, a marketing automation application, a customer relationship management (CRM) application, a business intelligence (BI) application, or a marketing automation application.

An Example 18 of the numerous embodiments includes the computer-implemented method of any one of Example 11 to Example 17 and further includes providing a user interface to access one or more functionalities to supply a second particular media asset of the media assets.

An Example 19 of the numerous embodiments includes the computer-implemented method of Example 18, where the one or more functionalities comprise a search functionality, a branding functionality, a layout selection functionality, a curation functionality, and a publication functionality.

An Example 20 of the numerous embodiments includes the computer-implemented method of any one of Example 11 to Example 19 and further includes causing the computing system to supply a third particular media asset comprising defined digital content including at least one of directed content or indicia defining a call-to-action.

An Example 21 of the numerous embodiments includes the computer-implemented method of Example 20, where supplying the third particular media asset to the first user device comprises causing the client application to direct the first user device to present the defined digital content as one or more overlays on the third particular media asset.

An Example 22 of the numerous embodiments includes a computer-readable non-transitory storage medium having processor-accessible instructions that, when executed by at least one processor of a computing system, cause the computing system to perform the computer-implemented method of any one of claims 11 to 21.

Any of the disclosed methods can be performed by computer-accessible instructions (e.g., computer-readable instructions and computer-executable instructions) embodied on computer-readable storage media. Computer readable media can be any available media that can be accessed by a computer. As an example, computer readable media can comprise “computer storage media” and “communications media.” “Computer storage media” can include volatile media and non-volatile media, removable media and non-removable media implemented in any methods or technology for storage of information such as computer-readable instructions, computer-executable instructions, data structures, program modules, or other data. Examples of computer-readable non-transitory storage media can comprise RAM; ROM; EEPROM; flash memory or other types of solid-state memory technology; CD-ROM; DVDs, BDs, or other optical storage; magnetic cassettes; magnetic tape; magnetic disk storage or other magnetic storage devices; or any other medium or article that can be used to store the desired information and which can be accessed by a computing device.

As used in this application, the terms “environment,” “system,” “module,” “component,” “interface,” and the like refer to a computer-related entity or an entity related to an operational apparatus with one or more defined functionalities. The terms “environment,” “system,” “module,” “component,” and “interface” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

Further, in the present specification and annexed drawings, terms such as “store,” “storage,” “data store,” “data storage,” “memory,” “repository,” and substantially any other information storage component relevant to the operation and functionality of a component of this disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions and/or computer-executable instructions), information structures, program modules, or other information objects.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A computing system, comprising:
at least one processor; and
at least one memory device having computer-executable instructions stored thereon that, in response to execution by the at least one processor, cause the computing system to:
receive media assets from one or more source devices via a source gateway;
retain the media assets within a distribution platform for presentation at user devices via a media presentation service, the user devices being remotely located relative to the computing system;
cause a client application in a first user device of the user devices to direct the first user device to present a user interface having multiple interface elements and a media player element to convey digital content comprising a particular media asset of the media assets, the client application being configured to access the media presentation service;
receive user activity data from the first user device during, the activity data identifying interaction with multiple second media assets of the media assets presented at the first user device during a defined period of time;
generate, using the user activity data, a user profile, the user profile identifying interest levels of a first subscriber account on multiple types of digital content contained within the multiple media assets; and
access, via one or more application programming interfaces (APIs), a third-party computing subsystem remotely located relative to the computing system, the third-party computing subsystem comprising third-party applications to manage subscriber accounts of the media presentation service.

2. The computing system of claim 1, further comprising a library of machine-learning models, the at least one memory device having further computer-executable instructions stored thereon that, in response to execution by the at least one processor, further cause the computing system to,
generate a personalized set of access functionalities by applying a first machine-learning model of the library of machine-learning models to the user activity data;
wherein a first access functionality of the personalized set of access functionalities provides a first type of interaction with the particular media asset; and
wherein a second access functionality of the personalized set of access functionalities provides a second type of interaction with the particular media asset.

3. The computing system of claim 2, wherein the personalized set of access functionalities comprises at least one of real-time translation, real-time transcription in a defined language; access to a document mentioned in the particular media asset; detection of haptic capable device and provisioning of four-dimensional (4D) experience during presentation of the particular media asset; a share function to forward information related to the particular media asset to a defined set of recipient devices; access to recommended content; or messaging functionality to send a message having a link to cited, recommended, or curated content related to the particular media asset; a scheduler functionality that prompts to add invites, adds invites, or sends invites for, a live presentation related to the particular media asset.

4. The computing system of claim 2, the at least one memory device having further computer-executable instructions stored thereon that, in response to execution by the at least one processor, further cause the computing system to,
generate predictions of engagement levels for prospective subscriber accounts of the media presentation service by applying a second machine-learning model of the library of machine-learning models to registrations to an event; and
generate predictions of load conditions of the computing system by applying a third machine-learning model of the library of machine-learning models to feature vectors comprising at least one of a first feature defining a number of scheduled events, a second feature defining a number of registrants for each timeslot of a presentation, a first categorical variable for the hour of the day for the presentation; or a second categorical variable for day of the week for the presentation.

5. The computing system of claim 1, wherein accessing, via the one or more APIs, the third-party computing subsystem comprises exchanging data between a second gateway of the computing system and at least one of the third-party applications.

6. The computing system of claim 5, wherein the third-party applications comprise one or more of a sales application, a marketing automation application, a customer relationship management (CRM) application, a business intelligence (BI) application, or a marketing automation application.

7. The computing system of claim 1, the at least one memory device having further computer-executable instructions stored thereon that, in response to execution by the at least one processor, further cause the computing system to provide a user interface to access one or more functionalities to supply a second particular media asset of the media assets.

8. The computing system of claim 7, wherein the one or more functionalities comprise a search functionality, a branding functionality, a layout selection functionality, a curation functionality, and a publication functionality.

9. The computing system of claim 1, the at least one memory device having further computer-executable instructions stored thereon that, in response to execution by the at least one processor, further cause the computing system to supply a third particular media asset comprising defined digital content including at least one of directed content or indicia defining a call-to-action.

10. The computing system of claim 9, wherein supplying the third particular media asset to the first user device comprises causing the client application to direct the first user device to present the defined digital content as one or more overlays on the third particular media asset.

11. A computer-implemented method, comprising:
receiving media assets from one or more source devices via a source gateway;
retaining the media assets within a distribution platform for presentation at user devices via a media presentation service, the user devices being remotely located relative to the computing system;
causing a client application in a first user device of the user devices to direct the first user device to present a user interface having multiple interface elements and a media player element to convey digital content comprising a particular media asset of the media assets, the client application being configured to access the media presentation service;
receiving user activity data from the first user device, the user activity data identifying interaction with multiple second media assets of the media assets presented at the first user device during a defined period of time; and
generating, using the activity data, a user profile identifying interest levels of a first subscriber account on multiple types of digital content contained within the multiple media assets.

12. The computer-implemented method of claim 11, further comprising a library of machine-learning models, the computer-implemented method further comprising,
generating a personalized set of access functionalities by applying a first machine-learning model of the library of machine-learning models to the user activity data;
wherein a first access functionality of the personalized set of access functionalities provides a first type of interaction with the particular media asset; and
wherein a second access functionality of the personalized set of access functionalities provides a second type of interaction with the particular media asset.

13. The computer-implemented method of claim 12, wherein the personalized set of access functionalities comprises at least one of real-time translation, real-time transcription in a defined language; access to a document mentioned in the particular media asset; detection of haptic capable device and provisioning of four-dimensional (4D) experience during presentation of the particular media asset; a share function to forward information related to the particular media asset to a defined set of recipient devices; access to recommended content; or messaging functionality to send a message having a link to cited, recommended, or curated content related to the particular media asset; a scheduler functionality that prompts to add invites, adds invites, or sends invites for, a live presentation related to the particular media asset.

14. The computer-implemented method of claim 11, further comprising,
generating predictions of engagement levels for prospective subscriber accounts of the media presentation service by applying a second machine-learning model of the library of machine-learning models to registrations to an event; and
generating predictions of load conditions of the computing system by applying a third machine-learning model library of machine-learning models to feature vectors comprising at least one of a first feature defining a number of scheduled events, a second feature defining a number of registrants for each timeslot of a presentation, a first categorical variable for the hour of the day for the presentation; or a second categorical variable for day of the week for the presentation.

15. The computer-implemented method of claim 11, further comprising accessing, via one or more application programming interfaces (APIs), a third-party computing subsystem remotely located relative to the computing system, the third-party computing subsystem comprising third-party applications to manage subscriber accounts of the media presentation service.

16. The computer-implemented method of claim 15, wherein the accessing, via the one or more APIs, the third-party computing subsystem comprises exchanging data between a second gateway of the computing system and at least one of the third-party applications.

17. The computer-implemented method of claim 16, wherein the third-party application comprise one or more of a sales application, a marketing automation application, a customer relationship management (CRM) application, a business intelligence (BI) application, or a marketing automation application.

18. The computer-implemented method of claim 11, further comprising providing a user interface to access one or more functionalities to supply a second particular media asset of the media assets.

19. The computer-implemented method of claim 18, wherein the one or more functionalities comprise a search functionality, a branding functionality, a layout selection functionality, a curation functionality, and a publication functionality.

20. The computer-implemented method of claim 11, further comprising causing the computing system to supply a third particular media asset comprising defined digital content including at least one of directed content or indicia defining a call-to-action, wherein supplying the third particular media asset to the first user device comprises causing the client application to direct the first user device to present the defined digital content as one or more overlays on the third particular media asset.

21. (canceled)

22. (canceled)
